(19) United States
(12) Patent Application Publication
(10) Pub. No.: US 2026/0276542 A1
(43) Pub. Date: Sep. 17, 2026

(54) BIOLOGICAL SAMPLE MATERIAL OBSERVATION SYSTEM, BIOLOGICAL SAMPLE MATERIAL OBSERVATION METHOD, AND DATA SET CREATION METHOD

(71) Applicant: SONY GROUP CORPORATION, TOKYO (JP)

(72) Inventors: AI GOTO, TOKYO (JP); TETSURO KUWAYAMA, TOKYO (JP); AYUMU TAGUCHI, TOKYO (JP)

(21) Appl. No.: 18/875,737

(22) PCT Filed: Jun. 16, 2023
(86) PCT No.: PCT/JP2023/022456

§ 371 Date: Dec. 17, 2024

(30) Foreign Application Priority Data
Jun. 24, 2022 (JP) 2022-101890

(51) Int. Cl. G01N 21/64

(52) U.S. Cl. CPC G01N 21/6428; G01N 2021/6439

(57) ABSTRACT

A biological sample material observation system includes a control unit. The control unit determines, based on a relationship between information related to a luminance distribution of first image data acquired by imaging a sample by a first imaging system and information related to a luminance distribution of second image data acquired by imaging the sample by a second imaging system, and based on information related to a luminance distribution of third image data acquired by imaging a biological sample material different from the sample by the first imaging system, an imaging condition to be used at a time of imaging the biological sample material by the second imaging system.

### FIELD

The present disclosure relates to a biological sample material observation system, a biological sample material observation method, and a data set creation method.

### BACKGROUND

In recent years, attention has been paid to a technique that enables quantitative analysis of biochemical information of a biological sample material such as cells of animals including humans and plants using a two-dimensional image obtained by imaging the biological sample material. For example, by using an imaging cytometer, it is possible to quantitatively analyze a complicated cell system by linking cell morphology information and localization/expression information of a plurality of proteins, which has been difficult to be obtained by analysis methods such as flow cytometer, microscope, or western blotting.

### CITATION LIST

### Patent Literature

Patent Literature 1: JP 2009-8793 A

### SUMMARY

### Technical Problem

For an information processing device including an imaging system such as an imaging cytometer, it is important to perform imaging under an appropriate exposure condition in order to achieve sufficient analysis accuracy. However, it is difficult to always select an exposure condition that enables the maximum use of the signal range detectable by the imaging device without saturating any pixel value of the visual field to be observed. Therefore, there has been a problem of deterioration of analysis accuracy as a result of imaging under an inappropriate exposure condition.

In view of this, the present disclosure proposes a biological sample material observation system, a biological sample material observation method, and a data set creation method capable of suppressing deterioration in analysis accuracy.

### Solution to Problem

In order to solve the above problem, a biological sample material observation system according to one embodiment of the present disclosure includes a control unit that determines, based on a relationship between information related to a luminance distribution of first image data acquired by imaging a sample by a first imaging system and information related to a luminance distribution of second image data acquired by imaging the sample by a second imaging system, and based on information related to a luminance distribution of third image data acquired by imaging a biological sample material different from the sample by the first imaging system, an imaging condition to be used at a time of imaging the biological sample material by the second imaging system.

### BRIEF DESCRIPTION OF DRAWINGS

FIG. 1 is a diagram illustrating a diagnosis support system according to a first embodiment.

FIG. 2 is a diagram for illustrating imaging processing according to the first embodiment.

FIG. 3 is a diagram for illustrating imaging processing according to the first embodiment.

FIG. 4 is a diagram illustrating processing of generating a partial image (tiled image) according to the first embodiment.

FIG. 5 is a diagram for illustrating a pathological image according to the first embodiment.

FIG. 6 is a diagram for illustrating a pathological image according to the first embodiment.

FIG. 7 is a block diagram illustrating a schematic configuration example of a microscopic imaging device according to the first embodiment.

FIG. 8 is a flowchart illustrating a schematic operation example of the microscopic imaging device according to the first embodiment.

FIG. 9 is a diagram for illustrating a two-dimensional histogram creation example according to the first embodiment.

FIG. 10 is a diagram for illustrating a histogram transformation matrix creation example according to the first embodiment.

FIG. 11 is a diagram for illustrating a modification of the histogram transformation matrix creation example according to the first embodiment.

FIG. 12 is a diagram for illustrating optimization of the histogram transformation matrix according to the first embodiment.

FIG. 13 is a diagram for illustrating estimation of luminance value distribution of an image acquired by a second imaging system according to the first embodiment.

FIG. 14 is a diagram for illustrating a method of determining an exposure time according to the first embodiment.

FIG. 15 is a diagram illustrating an example of a relationship between an exposure time and a luminance value according to the first embodiment.

FIG. 16 is a diagram (part 1) for illustrating a method of determining a reference luminance value according to the first embodiment.

FIG. 17 is a diagram (part 2) for illustrating a method of determining a reference luminance value according to the first embodiment.

FIG. 18 is a diagram (part 3) for illustrating a method of determining a reference luminance value according to the first embodiment.

FIG. 19 is a diagram for illustrating a method of determining an imaging condition according to the first embodiment.

FIG. 20 is a schematic diagram illustrating a relationship between each pixel and an emission spectrum of an observation target in a detection unit according to the first embodiment.

FIG. 21 is an explanatory diagram illustrating a relationship between an emission spectrum and a dynamic range in a detection region illustrated in FIG. 20.

FIG. 22 is a diagram (part 1) illustrating a flow of “(1) Creation of histogram transformation matrix” in a specific example of an imaging condition determination operation according to the first embodiment.

FIG. 23 is a diagram (part 2) illustrating a flow of “(1) Creation of histogram transformation matrix” in a specific example of the imaging condition determination operation according to the first embodiment.

FIG. 24 is a diagram (part 3) illustrating a flow of “(1) Creation of histogram transformation matrix” in a specific example of the imaging condition determination operation according to the first embodiment.

FIG. 25 is a diagram (part 4) illustrating a flow of “(1) Creation of histogram transformation matrix” in a specific example of the imaging condition determination operation according to the first embodiment.

FIG. 26 is a diagram (part 1) illustrating a flow of “(2) Estimation of luminance value distribution of image acquired by second imaging system” in a specific example of the imaging condition determination operation according to the first embodiment.

FIG. 27 is a diagram (part 2) illustrating a flow of “(2) Estimation of luminance value distribution of image acquired by second imaging system” in a specific example of the imaging condition determination operation according to the first embodiment.

FIG. 28 is a diagram (part 3) illustrating a flow of “(2) Estimation of luminance value distribution of image acquired by second imaging system” in a specific example of the imaging condition determination operation according to the first embodiment.

FIG. 29 is a diagram illustrating a flow of “(3) Determination of imaging condition in performing imaging in second imaging system” in a specific example of the imaging condition determination operation according to the first embodiment.

FIG. 30 is a diagram illustrating an example of second image data of an observation sample material acquired by main imaging using an imaging condition determined by a specific example of the imaging condition determination operation according to the first embodiment.

FIG. 31 is a diagram for comparing an estimation histogram illustrated in FIG. 28 with a one-dimensional histogram of the second image data illustrated in FIG. 30.

FIG. 32 is a flowchart illustrating an operation example of a microscopic imaging device according to a second embodiment.

FIG. 33 is a diagram illustrating an example of a test region according to the second embodiment.

FIG. 34 is a flowchart illustrating an operation example of a microscopic imaging device according to a first modification of the second embodiment.

FIG. 35 is a flowchart illustrating an operation example of a microscopic imaging device according to a second modification of the second embodiment.

FIG. 36 is a diagram illustrating an example of an imaging condition adjustment GUI according to a third embodiment.

FIG. 37 is a diagram illustrating another example of the imaging condition adjustment GUI according to the third embodiment.

FIG. 38 is a flowchart illustrating an operation example of a microscopic imaging device according to the third embodiment.

FIG. 39 is a diagram (part 1) illustrating a flow up to creation of a histogram transformation matrix in a specific example of a reference image generation operation according to the third embodiment.

FIG. 40 is a diagram (part 2) illustrating a flow up to creation of a histogram transformation matrix in a specific example of the reference image generation operation according to the third embodiment.

FIG. 41 is a diagram illustrating a flow from provisional imaging of an observation sample material to generation of pre-histogram in a specific example of the reference image generation operation according to the third embodiment.

FIG. 42 is a diagram (part 1) illustrating a flow up to creation of a luminance value conversion table in a specific example of the reference image generation operation according to the third embodiment.

FIG. 43 is a diagram (part 2) illustrating a flow up to creation of a luminance value conversion table in a specific example of the reference image generation operation according to the third embodiment.

FIG. 44 is a diagram (part 3) illustrating a flow up to creation of a luminance value conversion table in a specific example of the reference image generation operation according to the third embodiment.

FIG. 45 is a diagram (part 4) illustrating a flow up to creation of a luminance value conversion table in a specific example of the reference image generation operation according to the third embodiment.

FIG. 46 is a diagram (part 1) illustrating an example of a reference image generated by a specific example of the reference image generation operation according to the third embodiment.

FIG. 47 is a diagram (part 2) illustrating an example of a reference image generated by a specific example of the reference image generation operation according to the third embodiment.

FIG. 48 is a diagram illustrating an example of a schematic configuration of a fluorescence observation device according to a fourth embodiment.

FIG. 49 is a diagram illustrating an example of a schematic configuration of an observation unit according to the fourth embodiment.

FIG. 50 is a diagram illustrating an example of a sample according to the fourth embodiment.

FIG. 51 is an enlarged view illustrating a region in which the sample according to the fourth embodiment is irradiated with two line illumination beams.

FIG. 52 is a hardware configuration diagram illustrating an example of a computer according to the present disclosure.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

The present disclosure will be described in the following order of items.
0. Introduction
1. First Embodiment
1.1 System configuration
1.2 Pathological image
1.3 Microscope
1.4 Determination of imaging condition at time of main imaging
1.5 Schematic operation example
1.6 Detailed operation example
1.6.1 Creation of histogram transformation matrix
1.6.1.1 Modification of creating histogram transformation matrix
1.6.2 Estimation of luminance value distribution of image acquired by second imaging system
1.6.3 Determining imaging condition at imaging performed by second imaging system
1.6.4 Method of determining reference luminance value Vc
1.6.5 Signal gain adjustment method
1.7 Specific example
2. Second Embodiment
2.1 Modification
2.1.1 First modification
2.1.2 Second modification
3. Third Embodiment
3.1 Specific example
4. Fourth Embodiment
5. Hardware configuration

### 0. Introduction

For example, when a biological sample material that has undergone fluorescent labeling is irradiated with excitation light to detect a fluorescence signal from the biological sample material in a microscopic imaging device such as an imaging cytometer, selecting an imaging condition that can make maximum use of a detectable signal range without saturating any pixel value of a visual field to be observed has been a step requiring a lot of time and effort for the following reasons.

Since the acquired signal strength varies depending on the characteristics of the biological sample material (type of tissue, expression level of target molecule, wavelength characteristics of fluorescent dye, or other chemical modification means), it is necessary to set an appropriate imaging condition for each biological sample material on each occasion.

Since the signal strength is different for each region on the biological sample material, it is necessary to determine an imaging condition appropriate for imaging the entire sample material in both a case where the entire sample material is imaged under the same imaging condition and a case where the entire sample material is imaged with different imaging conditions for each part.

In order to set an appropriate imaging condition for each biological sample material, it is necessary to calculate the imaging condition based on an actual signal acquired by an actual imaging system. For example, in a conceivable method, provisional imaging is performed under an imaging condition provisionally determined once before actual imaging, and an imaging condition to be used in main imaging is determined based on an actual signal acquired by the provisional imaging.

However, such a method of determining an imaging condition causes the biological sample material to be exposed to the excitation light and damaged every repeated imaging for exposure adjustment, leading to an occurrence of photobleaching. The occurrence of photobleaching leads to a problem of a failure in acquisition of accurate quantitative data in subsequent quantitative analysis.

In view of this, the following embodiment proposes a method of predicting information related to the luminance distribution acquired in the main imaging (for example, occurrence frequency of each luminance value; hereinafter, referred to as a luminance value distribution) and calculating an imaging condition in the main imaging based on the predicted luminance value distribution. The following embodiment can minimize the damage given to the biological sample material at the time of provisional imaging, making it possible to acquire more accurate quantitative data in the subsequent quantitative analysis.

### 1. First Embodiment

First, a first embodiment of the present disclosure will be described in detail with reference to the drawings. The following will describe an example in which an application target of the biological sample material observation system, the biological sample material observation method, and the data set creation method according to the present disclosure is set to a diagnosis support system that supports diagnosis of a pathological image by a pathologist or the like. However, the present disclosure is not limited to this system, and is applicable to various systems that analyze a stained or unstained biological sample material or other sample materials based on an image, such as an analysis system for companion diagnosis that inspects the efficacy of a therapeutic agent for a patient before treatment, a system that observes the growth state of a plant, a system that analyzes the composition of minerals or the like.

### 1.1 System Configuration

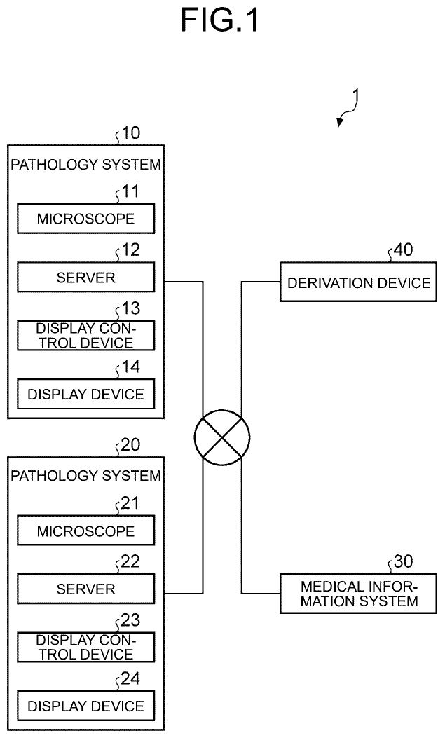

FIG. 1 is a diagram illustrating a diagnosis support system according to the present embodiment. As illustrated in FIG. 1, the diagnosis support system 1 includes a pathology system 10, a pathology system 20, a medical information system 30, and a derivation device 40.

The pathology system 10 is a system mainly used by a pathologist, and is applied to a laboratory and a hospital, for example. As illustrated in FIG. 1, the pathology system 10 includes a microscope 11, a server 12, a display control device 13, and a display device 14.

The microscope 11 is an imaging device that has a function of an optical microscope, captures an image of a specimen as an observation target placed on a glass slide, and acquires a pathological image (an example of a medical image) being a digital image.

Here, the specimen as an observation target may be prepared for the purpose of pathological diagnosis or the like from a biologically originated specimen (hereinafter, referred to as a biological sample material) such as a body sample or a tissue sample collected from a human body. The specimen may be a tissue section, a cell, or a fine particle, and there is no particular limitation regarding details of the specimen, such as the type of tissue (for example, organ or the like) used, the type of disease to be targeted, attributes of the subject (for example, age, sex, blood type, race, and the like), or the lifestyle of the subject (for example, dietary habits, exercise habits, and smoking habits). For example, the specimen may be a specimen obtained by fixing a tissue section, a cell, or the like to a glass slide by a predetermined fixing method and applying fluorescent labeling on the specimen. However, the specimen is not limited to a biological sample material that has undergone fluorescent labeling, and may be various other sample materials such as a biological sample material that has not undergone fluorescent labeling.

The fluorescent labeling may use not only a fluorescent dye, but also a fluorescent labeled antibody, a fluorescence in situ hybridization (FISH) antibody, a fluorescent fusion protein, or the like. Incidentally, a tissue section can include, for example, a section before staining of a tissue section to be stained (hereinafter, it is also simply referred to as a section), a section adjacent to the stained section, a section different from the stained section in a same block (sampled from the same location as the stained section), a section in a different block in a same tissue (sampled from a different place from the stained section), and a section collected from a different patient.

The server 12 is a device that stores and preserves a pathological image captured by the microscope 11 in a storage unit (not illustrated). When having received a viewing request from the display control device 13, the server 12 retrieves a pathological image from a storage unit (not illustrated) and transmits the retrieved pathological image to the display control device 13.

The display control device 13 transmits a request for viewing a pathological image received from a user such as a clinician or a pathologist to the server 12. The display control device 13 then controls the display device 14 to display a pathological image received from the server 12.

The display device 14 has a screen using liquid crystal, electro-luminescence (EL), and cathode ray tube (CRT), for example. The display device 14 may be a device achieving 4K or 8K resolution, or may be formed by a plurality of display devices. The display device 14 displays the pathological image controlled to be displayed by the display control device 13. In addition, the server 12 stores the viewing history information related to a region of the pathological image observed by the pathologist via the display device 14. The viewing history information may be, for example, information related to a viewing history of a pathological image acquired by the user such as a clinician or a pathologist in a past case.

The pathology system 20 is a system applied to a hospital different from the hospital having the pathology system 10. The pathology system 20 includes a microscope 21, a server 22, a display control device 23, and a display device 24. The components included in the pathology system 20 are similar to those of the pathology system 10, and thus description thereof is omitted.

The medical information system 30 is a system that stores information related to diagnosis of patients. For example, when it is difficult to diagnose a state of the disease only from an image in an endoscopic examination or the like in a predetermined hospital, a biopsy may be performed to perform a definite diagnosis by pathological diagnosis. A specimen prepared from tissue collected from a patient is imaged by the microscope 11 of the pathology system 10, and a pathological image obtained by imaging is stored in the server 12. The display control device 13 controls to display the pathological image on the display device 14, with which pathological diagnosis is performed by a pathologist using the pathology system 10. The clinician performs a definite diagnosis based on a pathological diagnosis result, and a result of the definite diagnosis is stored in the medical information system 30. The medical information system 30 stores information related to diagnosis, such as information for identifying a patient, patient disease information, examination information and image information used for diagnosis, a diagnosis result, and prescription medicine. Note that the medical information system 30 is referred to as an electronic medical record system or the like.

Furthermore, in the present embodiment, the pathological image acquired by a microscope 11/21 may be a pathological image included in a tiled image group (also referred to as a mipmap) having a pyramid structure created for each case. Although details of the tiled image group having the pyramid structure will be described below, the tiled image group is schematically an image group including pathological images with higher magnification and higher resolution in lower layers. In the same case, the image group of each layer represents one identical specimen. In the present description, an entire image including an image group of the lowermost layer, in other words, the highest magnification, is referred to as a whole slide image.

The derivation device (analysis unit) 40 separates a fluorescence signal and an autofluorescence signal from the acquired pathological image, and performs various types of processing using these signals. For example, the derivation device 40 may extract a fluorescence signal from image information of another specimen by performing subtraction processing (also referred to as “background subtraction processing”) on the image information of the another specimen using the autofluorescence signal after separation. When there is a plurality of specimens that are the same or similar in terms of the tissue used for the specimen, the type of the target disease, the attribute of the subject, the lifestyle of the subject, and the like, there is a high possibility that the autofluorescence signals of these specimens are similar to each other. The similar specimen described here includes, for example, a tissue section before staining of a tissue section to be stained (hereinafter, referred to as a section), a section adjacent to the stained section, a section different from the stained section in a same block (sampled from the same location as the stained section), a section in a different block in a same tissue (sampled from a different location from the stained section), and a section collected from a different patient. Therefore, when the autofluorescence signal is successfully extracted from a certain specimen, the derivation device 40 may remove the autofluorescence signal from image information of another specimen to extract the fluorescence signal from the image information of the another specimen. Furthermore, when calculating an S/N value using the image information of another specimen, the derivation device 40 can improve the S/N value by using the background after removing the autofluorescence signal.

Furthermore, for example, the derivation device (analysis unit) 40 may train a learning model using a pathological image acquired in a past case and diagnostic information given by a clinician, a pathologist, or the like for the case as training data, and may input a pathological image to be newly diagnosed to the trained learning model (hereinafter, referred to as the trained model) so as to derive a result of diagnosis estimation for the pathological image.

This will be described using the example of FIG. 1. In the example of FIG. 1, it is assumed that diagnosis-related information from a pathologist is accumulated daily in the server 12 of the pathology system 10. That is, the server 12 stores a first pathological image corresponding to a first affected tissue. In addition, in the example of FIG. 1, the derivation device 40 is supposed to provide diagnosis support information to the pathology system 20.

First, the derivation device 40 acquires the daily accumulated first pathological images from the server 12 of the pathology system 10. In addition, the derivation device 40 acquires diagnostic information related to a diagnosis result corresponding to the first pathological image from the medical information system 30. The derivation device 40 trains the learning model using the first pathological image and its corresponding diagnostic information as training data to generate a trained model for estimating a diagnosis result from a second pathological image corresponding to a second affected tissue different from the first affected tissue.

Now, it is assumed that the second pathological image corresponding to the second affected tissue has been generated by the microscope 21 in the pathology system 20. At this time, when having received a request to display the second pathological image from the user such as a clinician or a pathologist, the display control device 23 transmits the second pathological image to the derivation device 40. The derivation device 40 uses the trained model to derive a diagnostic estimation result for the case from the second pathological image (derivation unit), and outputs the derived estimation result to the display control device 23 as a part of diagnosis support information.

The derivation device 40 may output a whole slide image of the specimen to the display control device 23 as a part of the diagnosis support information.

Although the above is an example of training the learning model using the pathological image stored in the server 12 of the pathology system 10 as training data, the derivation device 40 may train the learning model using the pathological image stored in the server 22 of the pathology system 20 as training data, or may train the learning model using both the pathological image stored in the server 12 and the pathological image stored in the server 22 as the training data. That is, the derivation device 40 can use any pathological image as training data as long as it has been viewed in the past. While the above description is an example in which the derivation device 40 provides diagnosis support information to the display control device 23, the derivation device 40 may provide the diagnosis support information to the display control device 13.

Furthermore, although the pathology system 10 and the pathology system 20 have been described as separate from each other, the pathology system 10 and the pathology system 20 may be the same system. More specifically, the diagnosis support system 1 may include the pathology system 10 alone. In this case, the derivation device 40 trains the learning model using the first pathological image stored in the server 12 as training data, and provides diagnosis support information to the display control device 13 in response to a request from the display control device 13. In addition, the number of pathology systems included in the diagnosis support system 1 may be three or more. In this case, the derivation device 40 may collect pathological images accumulated in each pathology system to generate training data, and may train the learning model using the training data. Furthermore, in the above example, the medical information system 30 may be the same system as the pathology system 10 or 20. That is, the diagnostic information may be stored in the server 12 or 22.

Note that the derivation device 40 according to the present embodiment may be implemented by a server, a cloud server, or the like arranged on a network, or may be implemented by a server 12/22 arranged in the pathology system 10/20. Alternatively, the derivation device 40 may be implemented by being distributed on systems constructed via a network, such that a part of the derivation device 40 is implemented by a server, a cloud server, or the like located on a network and the remaining part is implemented by the server 12/22 of the pathology system 10/20.

The diagnosis support system 1 has been briefly described above. Hereinafter, in the description of the configuration and processing of each device which will be given in detail, various types of information as a premise of the description (data structure of a pathological image and diagnostic information) will be first described. Note that the following description is an example in which the derivation device 40 trains a learning model using training data accumulated in the pathology system 10 and provides diagnosis support information to the pathology system 20.

### 1.2 Pathological Image

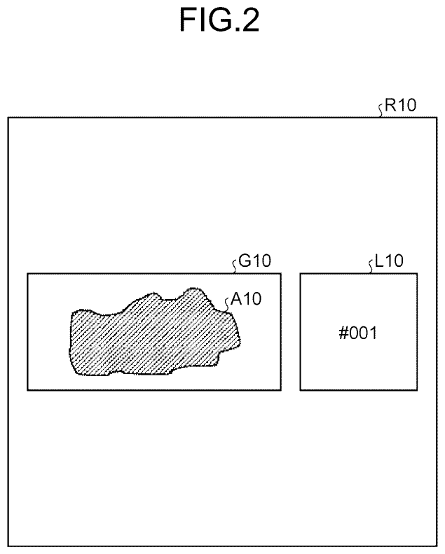

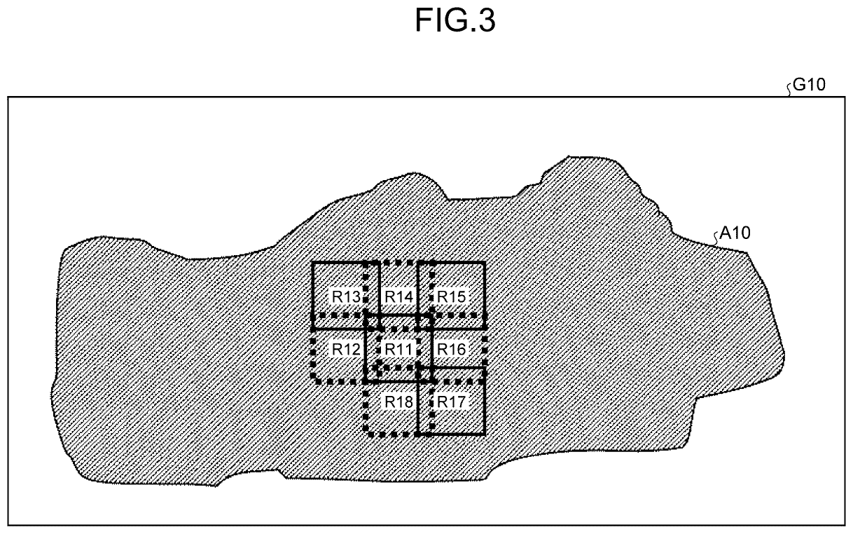

Next, a pathological image according to the present embodiment will be described. As described above, a pathological image is generated by imaging a specimen using the microscope 11 or the microscope 21. First, imaging processing using the microscope 11 and the microscope 21 will be described with reference to FIGS. 2 and 3. FIGS. 2 and 3 are diagrams illustrating imaging processing according to the present embodiment. Since the microscope 11 and the microscope 21 perform similar imaging processing, the microscope 11 will be described here as an example. The microscope 11 described below includes a low-resolution imaging unit (also referred to as a first imaging system) for imaging at low resolution and a high-resolution imaging unit (also referred to as a second imaging system) for imaging at high resolution.

In FIG. 2, the region that can be imaged by the microscope 11, namely, an imaging region R10, includes a glass slide G10 on which a specimen A10 is mounted. The glass slide G10 is placed on a stage (not illustrated), for example. The microscope 11 images the imaging region R10 by the low-resolution imaging unit to generate a whole slide image, which is a pathological image of the entire specimen A10. Label information L10 illustrated in FIG. 2 includes description of identification information (for example, a character string or a QR code (registered trademark)) for identifying the specimen A10. By associating the identification information described as the label information L10 with a patient, it is possible to specify the patient corresponding to the whole slide image. In the example of FIG. 2, “#001” is described as identification information. The label information L10 may also include a simple description of the specimen A10.

Subsequently, after generating the whole slide image, the microscope 11 specifies a region where the specimen A10 exists from the whole slide image, and uses the high-resolution imaging unit to sequentially image each divided region, obtained by dividing the region where the specimen A10 exists, in each predetermined size. For example, as illustrated in FIG. 3, the microscope 11 first images a region R11, and generates a high-resolution image I11 that is an image representing a partial region of the specimen A10. Subsequently, the microscope 11 moves the stage to image a region R12 by the high-resolution imaging unit, and generates a high-resolution image I12 corresponding to the region R12. Similarly, the microscope 11 generates high-resolution images I13, I14, . . . corresponding to regions R13, R14, Although FIG. 3 only illustrates regions up to the region R18, the microscope 11 sequentially moves the stage to image all divided regions corresponding to the specimen A10 by the high-resolution imaging unit, and generates a high-resolution image corresponding to each divided region.

Meanwhile, the glass slide G10 might accidentally move on the stage when the state is moved. Movement of the glass slide G10 might cause generation of a non-imaged region of the specimen A10. As illustrated in FIG. 3, the microscope 11 performs imaging by the high-resolution imaging unit such that adjacent divided regions partially overlap each other, making it possible to prevent the occurrence of the non-imaged region even when the glass slide G10 moves.

Note that the low-resolution imaging unit and the high-resolution imaging unit described above may include different optical systems or the same optical system. When the optical system is the same, the microscope 11 changes the resolution according to the imaging target. Although the above description is an example in which the imaging region is changed by moving the stage, the imaging region may be changed by moving the optical system (high-resolution imaging unit or the like) by the microscope 11. Furthermore, FIG. 3 illustrates an example in which the microscope 11 captures an image starting from the central portion of the specimen A10. However, the microscope 11 may image the specimen A10 in an order different from the imaging order illustrated in FIG. 3. For example, the microscope 11 may capture an image starting from the outer peripheral portion of the specimen A10. Furthermore, the above is an example in which the high-resolution imaging unit images only the region where the specimen A10 exists. However, since there is a case where it is difficult to accurately detect the region where the specimen A10 exists, the microscope 11 may divide the entire region of the imaging region R10 or the glass slide G10 illustrated in FIG. 2 and perform imaging with the high-resolution imaging unit.

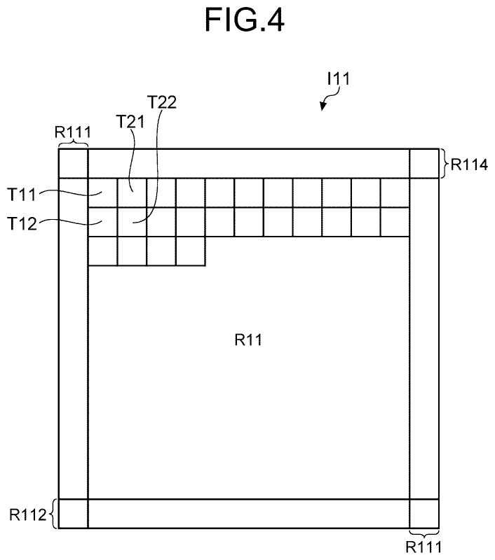

Subsequently, each high-resolution image generated by the microscope 11 is divided into a predetermined size. This generates a partial image (hereinafter, referred to as a tiled image) from the high-resolution image. This point will be described with reference to FIG. 4. FIG. 4 is a diagram illustrating processing of generating a partial image (tiled image). FIG. 4 illustrates the high-resolution image I11 corresponding to the region R11 illustrated in FIG. 3. Note that the following description assumes that a partial image is generated from a high-resolution image by the server 12. However, the partial image may be generated by a device (for example, an information processing device mounted inside the microscope 11, or the like) other than the server 12.

In the example illustrated in FIG. 4, the server 12 generates 100 tiled images T11, T12, . . . by dividing one high-resolution image I11. For example, when the high-resolution image I11 has a resolution 2560×2560 [pixels], the server 12 generates, from the high-resolution image I11, hundred tiled images T11, T12, . . . each of which having a resolution 256×256 [pixels]. Similarly, the server 12 generates tiled images by dividing other high-resolution images into similar sizes.

Note that, in the example of FIG. 4, regions R111, R112, R113, and R114 are regions overlapping other adjacent high-resolution images (not illustrated in FIG. 4). The server 12 performs aligning of the overlapping regions by a technique such as template matching to perform stitching processing on the adjacent high-resolution images. In this case, the server 12 may generate the tiled image by dividing the high-resolution image after the stitching processing. Alternatively, the server 12 may generate tiled images of regions other than the regions R111, R112, R113, and R114 before the stitching processing, and then generate tiled images of the regions R111, R112, R113, and R114 after the stitching processing.

In this manner, the server 12 generates a tiled image that is a minimum unit of the captured image of the specimen

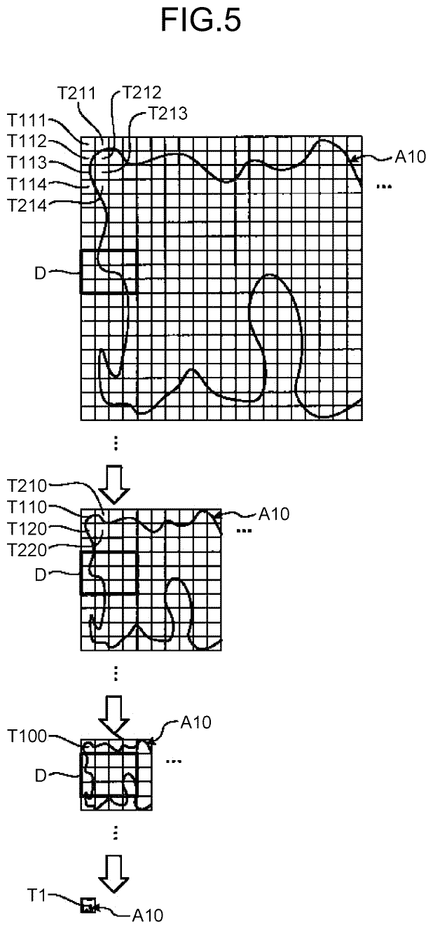

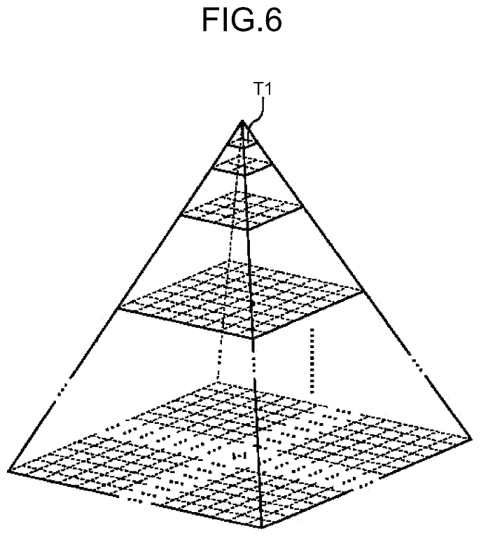

A10. The server 12 then sequentially combines the tiled images of the minimum unit to generate tiled images having different hierarchies. Specifically, the server 12 generates one tiled image by combining a predetermined number of adjacent tiled images. This will be described with reference to FIGS. 5 and 6. FIGS. 5 and 6 are diagrams illustrating a pathological image according to the present embodiment.

The upper part of FIG. 5 illustrates a tiled image group of a minimum unit generated from each high-resolution image by the server 12. In the example in the upper part of FIG. 5, by combining four tiled images T111, T112, T211, and T212 adjacent to each other among the tiled images, the server 12 generates one tiled image T110. For example, when the resolution of each of the tiled images T111, T112, T211, and T212 is 256×256, the server 12 generates a tiled image T110 having a resolution of 256×256. Similarly, the server 12 generates a tiled image T120 by combining four tiled images T113, T114, T213, T214 adjacent to each other. In this manner, the server 12 generates a tiled image obtained by combining a predetermined number of tiled images of the minimum unit.

Furthermore, among the tiled images obtained by combining the tiled images of the minimum unit, the server 12 further combining tiled images adjacent to each other to generate another tiled image. In the example of FIG. 5, the server 12 generates one tiled image T100 by combining four tiled images T110, T120, T210, and T220 adjacent to each other. For example, when the tiled images T110, T120, T210, and T220 each have a resolution 256×256, the server 12 generates a tiled image T100 having the resolution 256×256. For example, based on a tiled image having a resolution of 512×512 obtained by combining four tiled images adjacent to each other, the server 12 applies 4-pixel averaging, a weighting filter (processing of weighting close pixels more than far pixels), ½ thinning processing, or the like, on the image to generate an image having a resolution of 256×256.

By repeating such combining processing, the server 12 finally generates one tiled image having a resolution similar to the resolution of the tiled image of the minimum unit. For example, when the tiled image of the minimum unit has a resolution 256×256 as in the above example, the server 12 repeats the above-described combining processing to generate one tiled image T1 having a final resolution of 256×256.

FIG. 6 schematically illustrates the tiled image illustrated in FIG. 5. In the example illustrated in FIG. 6, the lowermost layer tiled image group includes a minimum unit of tiled image generated by the server 12. Furthermore, the tiled image group in the second lowest layer is a tiled image obtained by combining the tiled image groups of the lowermost layer. An uppermost tiled image T1 indicates one tiled image to be finally generated. In this manner, the server 12 generates, as a pathological image, a tiled image group having a hierarchy such as a pyramid structure illustrated in FIG. 6.

Note that a region D illustrated in FIG. 5 is an example of a region displayed on a display screen of the display device 14 or 24. For example, the resolution displayable by the display device, in an assumable case, corresponds to a tiled image of three vertical images and a tiled image of four horizontal images. In this case, as in the region D illustrated in FIG. 5, the level of detail of the specimen A10 displayed on the display device varies depending on the hierarchy to which the tiled image to be displayed belongs. For example, when the tiled image in the lowermost layer is used, a small region in the specimen A10 is displayed in a high level of detail. In addition, as the tiled image goes toward the upper layers, a wider region in the specimen A10 is displayed in a low level of detail.

The server 12 stores tiled images of the individual hierarchies as illustrated in FIG. 6 in a storage unit (not illustrated). For example, the server 12 stores each tiled image together with tile identification information (an example of partial image information) with which each tiled image can be uniquely identified. In this case, when having received a tiled image acquisition request including tile identification information from another device (for example, the display control device 13 or the derivation device 40), the server 12 transmits a tiled image corresponding to the tile identification information to the another device. Furthermore, for example, the server 12 may store each tiled image together with hierarchy identification information for identifying each hierarchy and tile identification information with which tiles can be uniquely identified in a same hierarchy. In this case, when the server 12 has received a tiled image acquisition request including hierarchy identification information and tile identification information from the another device, the server 12 transmits, to the another device, a tiled image corresponding to the tile identification information among the tiled images belonging to the hierarchy corresponding to the hierarchy identification information.

Note that the server 12 may store the tiled images of the respective hierarchies as illustrated in FIG. 6 in a storage device other than the server 12. For example, the server 12 may store tiled images of each hierarchy in a cloud server or the like. Furthermore, the processing of generating tiled images illustrated in FIGS. 5 and 6 may be executed by a cloud server or the like.

Furthermore, the server 12 need not store the tiled images of all the hierarchies. For example, the server 12 may store only the tiled image of the lowermost layer, may store only the tiled image of the lowermost layer and the tiled image of the uppermost layer, or may store only the tiled image of a predetermined hierarchy (for example, odd-numbered hierarchies, even-numbered hierarchies, and the like.). At this time, when the tiled image requested from another device is not stored in the server 12, the server 12 generates a tiled image requested from the another device by dynamically combining the stored tiled images. In this manner, by thinning out the tiled images to be stored, the server 12 can prevent the storage capacity constraint.

Furthermore, although the imaging conditions are not mentioned in the above example, the server 12 may store the tiled images of the respective hierarchies as illustrated in FIG. 6 for each imaging condition. Examples of the imaging condition include a focal length with respect to a subject (such as the specimen A10). For example, the microscope 11 may capture images of the same subject while changing the focal length. In this case, the server 12 may store the tiled image of each hierarchy as illustrated in FIG. 6 for each focal length. Incidentally, the reason for changing the focal length is that, some of the specimen A10 may be translucent, and thus, has a focal length suitable for imaging the surface of the specimen A10 and a focal length suitable for imaging an inner portion of the specimen A10. In other words, by changing the focal length, the microscope 11 can generate a pathological image of the surface of the specimen A10 or a pathological image of an inner portion of the specimen A10.

In addition, a staining condition for the specimen A10 is another example of the imaging condition. Specifically, in pathological diagnosis, a specific portion (for example, a cell nucleus or the like) of the specimen A10 is stained with a luminous material in some cases. The luminous material is, for example, a substance that emits light when irradiated with light of a specific wavelength. In some cases, different luminous materials may be used to stain the same specimen A10. In this case, the server 12 may store a tiled image of each hierarchy as illustrated in FIG. 6 for each stained luminous material.

Furthermore, the number and resolution of the tiled images described above are merely examples, and can be appropriately changed depending on the system. For example, the number of tiled images combined by the server 12 is not limited to four. For example, the server 12 may repeat processing of combining 3×3=9 tiled images. Although the above is an example in which the resolution of the tiled image is 256×256, the tiled image may have resolution other than 256×256.

By using software adopting a system capable of handling the tiled image group having the hierarchical structure described above, the display control device 13 extracts a desired tiled image from the tiled image group having the hierarchical structure according to an input operation of the user via the display control device 13, and outputs the extracted tiled image to the display device 14. Specifically, the display device 14 displays an image of a certain part selected by the user among images of certain resolution selected by the user. With such processing, the user can obtain a feeling of observing the specimen while changing the observation magnification. That is, the display control device 13 functions as a virtual microscope. The virtual observation magnification here actually corresponds to the resolution.

The above has described the case where the high-resolution image of the entire specimen A10 is acquired by the high-resolution imaging unit by sequentially imaging each divided region obtained by dividing the region including the specimen A10 for each predetermined size. However, the method of acquiring the high-resolution image of the specimen A10 is not limited thereto, and it is allowable to adopt various imaging methods such as a method of acquiring the high-resolution image of the entire specimen A10 in one shot.

### 1.3 Microscope

Next, a microscope 11/12 according to the present embodiment will be described. Note that, in the following description, the microscope 11/12 will be described as a microscopic imaging device 100.

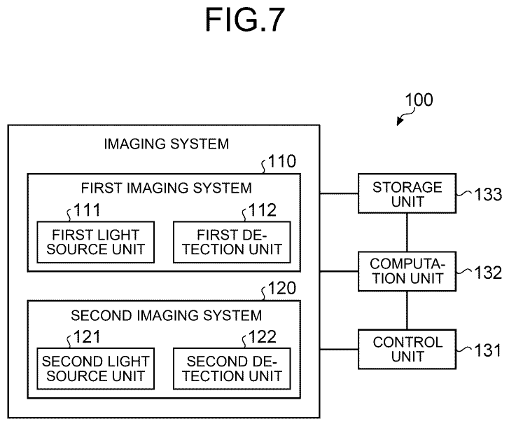

In FIG. 7, the microscopic imaging device 100 according to the present embodiment includes a first imaging system 110 and a second imaging system 120 as imaging systems. Note that the first imaging system 110 and the second imaging system 120 may be structurally different imaging systems, or may have a configuration in which at least a part (for example, an optical system, a detection unit, and the like) is implemented by driving the same imaging system under different drive conditions.

Furthermore, the microscopic imaging device 100 may include a control unit 131, a computation unit 132, and a storage unit 133 as other components.

The control unit 131 is constituted with an information processing device such as a central processing unit (CPU), and may execute control of the entire microscopic imaging device 100 including the first imaging system 110 and the second imaging system 120, control of the illumination intensity of the first light source unit 111 of the first imaging system 110 and/or the second light source unit 121 of the second imaging system 120, and the like. Furthermore, the control unit 131 may control the imaging conditions for the first imaging system 110 and/or the second imaging system 120 based on the imaging conditions calculated by the computation unit 132.

The computation unit 132 is constituted with, for example, a computation processing device such as a digital signal processor (DSP), a field programmable gate array (FPGA), or a microprocessor, and executes various types of processing on image data output from the imaging system. For example, using the image data acquired by the first imaging system 110 (also referred to as first image data) and the image data acquired by the second imaging system 120 (also referred to as second image data), the computation unit 132 calculates a histogram transformation matrix indicating a relationship between the luminance value of the first image data and the luminance value of the second image data. That is, the histogram transformation matrix may be information indicating a relationship between the first image data acquired by the first imaging system 110 and the second image data acquired by the second imaging system 120, and the relationship may be information indicating a correspondence relationship between information related to a luminance distribution of the first image data acquired by the first imaging system 110 in the past and information related to a luminance distribution of the second image data acquired by the second imaging system 120 in the past. Note that the control unit 131 and the computation unit 132 do not need to be clearly divided, and all or a part of the control unit 131 may operate as the computation unit 132.

The storage unit 133 includes, for example, a storage device such as flash memory, a hard disk drive (HDD), or a solid state drive (SSD), and stores various programs and parameters for implementing functions of each unit in the microscopic imaging device 100, such as the control unit 131 or the computation unit 132, image data output from the imaging system, results of processing performed by the computation unit 132, such as a histogram transformation matrix and imaging conditions.

The first imaging system 110 corresponds to the above-described low-resolution imaging unit, and performs provisional imaging of the specimen A10 placed on a glass slide, for example, to acquire a low-resolution image of the entire specimen A10. While details of the provisional imaging will be described below, the provisional imaging may basically be, for example, imaging in which a low-resolution image of a part or the whole of the specimen A10 is acquired under an imaging condition that causes less damage to the specimen A10 than at the time of acquiring the high-resolution image by the second imaging system 120 being the main imaging.

At that time, the imaging condition changed in the main imaging from the provisional imaging can be at least one of an exposure time, a signal gain, diaphragm, and excitation light intensity. In the present description, the image acquired in the provisional imaging is to be an image having a resolution lower than that of the image acquired in the main imaging. However, the image is not limited thereto, and may be a high-resolution image having a resolution equal to or higher than that of the image acquired in the main imaging.

On the other hand, the second imaging system 120 corresponds to the high-resolution imaging unit described above, and performs imaging of the specimen A10 placed on a glass slide one or a plurality of times (main imaging), for example, to acquire a high-resolution image of the entire specimen A10. The acquired high-resolution image of the entire specimen A10 may be used to create a tiled image group (mipmap) having a pyramidal hierarchical structure in which the magnification (also referred to as resolution) becomes higher as the layer becomes lower with gradual reduction in resolution.

The first imaging system 110 may include, for example, a first light source unit 111 that emits excitation light for generating fluorescence on the specimen A10, and a first detection unit 112 that acquires a two-dimensional image with fluorescence emitted from the specimen A10 by the excitation light of the first light source unit 111. Similarly, the second imaging system 120 may include, for example, a second light source unit 121 that emits excitation light for generating fluorescence on the specimen A10, and a second detection unit 122 that acquires a two-dimensional image with fluorescence emitted from the specimen A10 by the excitation light of the second light source unit 121.

Each of the first light source unit 111 and the second light source unit 121 includes, for example, an optical system including an irradiation lens and one or more excitation light sources, and irradiates the specimen A10 placed on a glass slide and mounted on a predetermined stage with excitation light.

The first light source unit 111 and the second light source unit 121 may use light sources having mutually different emission spectra. Note that the excitation light emitted from at least the second light source unit 121 is assumed to include light having a wavelength capable of exciting a fluorescent labeled molecule used for fluorescent staining. Furthermore, one or more laser units, light-emitting diodes (LEDs), or the like may be used for the first light source unit 111 and the second light source unit 121.

The first detection unit 112 and the second detection unit 122 each include: for example, an optical system including an objective lens; and an image sensor, so as to acquire a two-dimensional image of fluorescence emitted from the specimen A10 by irradiation with the excitation light. The image sensor may be a one-dimensional sensor in which pixels are arranged in line, or may be a two-dimensional sensor in which pixels are arranged in a two-dimensional lattice pattern. Note that the first detection unit 112 and the second detection unit 122 may image the specimen A10 at different magnifications (or resolutions).

The first light source unit 111 and the second light source unit 121 may be structurally different light source units, or may have a configuration in which at least a part is implemented by driving the same light source unit under different drive conditions (excitation light intensity, for example). Similarly, the first detection unit 112 and the second detection unit 122 may be structurally different detection units, or may have a configuration in which at least a part is implemented by driving the same detection unit under different drive conditions (for example, at least one of exposure time, signal gain, diaphragm, and the like).

Furthermore, at least a part of the optical system of the first light source unit 111 and/or the second light source unit 121 and at least a part of the optical system of the first detection unit 112 and/or the second detection unit 122 may have an identical configuration. For example, the irradiation lens in the optical system of the first light source unit 111 and/or the second light source unit 121 and the objective lens in the optical system of the first detection unit 112 and/or the second detection unit 122 may be the same lens.

In the configuration as described above, the control unit 131 and/or the computation unit 132 specifies a relationship (corresponding to a histogram transformation matrix) related to the luminance value distribution between the fluorescence signal acquired by the first imaging system 110 and the fluorescence signal acquired by the second imaging system 120, predicts the luminance value distribution of the image to be captured by the second imaging system 120 using the image captured by the first imaging system 110 based on the specified relationship, and determines an imaging condition of the second imaging system 120 based on the predicted luminance value distribution. Hereinafter, the details will be described with reference to the drawings.

### 1.4 Determination of Imaging Condition at Time of Main Imaging

In the present embodiment, the method of determining the imaging condition at the time of main imaging mainly includes the following three steps.
(1) Creation of histogram transformation matrix
(2) Estimation of luminance value distribution of image acquired by second imaging system
(3) Determining imaging condition at imaging performed by second imaging system

In “(1) Creation of histogram transformation matrix”, a histogram transformation matrix is created using image data of a biological sample material imaged in the past. Specifically, the same biological sample material is imaged by both the first imaging system 110 and the second imaging system 120, and a pair of pieces of image data acquired by each imaging system is used to create a two-dimensional histogram in which pixel values of the individual pieces of image data are set to the vertical axis and the horizontal axis. The created two-dimensional histogram is used as a basis to compose a histogram transformation matrix for estimating a luminance value distribution of image data to be acquired by the second imaging system 120 from the image data acquired by the first imaging system 110.

In “(2) Estimation of luminance value distribution of image acquired by second imaging system”, the histogram transformation matrix is used to estimate a luminance value distribution of image data (second image data) to be acquired by the second imaging system 120 from the image data (first image data) acquired by imaging by the first imaging system 110. Specifically, a biological sample material to be actually observed (hereinafter, also referred to as an observation sample material) (corresponding to the specimen A10 in the present example) is imaged by the first imaging system 110 so as to create a one-dimensional histogram (also referred to as a pre-histogram) indicating a luminance value distribution of the first image data obtained by the imaging. Subsequently, the created pre-histogram and the histogram transformation matrix composed in (1) undergoes computation to compose a one-dimensional histogram (also referred to as an estimation histogram) that estimates the luminance value distribution of the second image data to be acquired by the second imaging system.

In “(3) Determination of imaging condition at imaging performed by second imaging system”, the imaging condition at imaging of the biological sample material (specimen A10) by the second imaging system 120 is determined based on the luminance value on the estimation histogram. For example, an imaging condition may be calculated such that a luminance value (hereinafter, also referred to as a reference luminance value) as an index in the estimation histogram becomes a luminance value which is appropriate (hereinafter, also referred to as an appropriate luminance value), and the calculated imaging condition may be determined as an imaging condition to be applied to the second imaging system 120 at the time of main imaging.

By performing the main imaging using the imaging condition determined through the above steps, it is possible to perform the main imaging under the imaging condition suitable for image analysis while setting the imaging condition at the time of the provisional imaging to the imaging condition that causes less damage to the biological sample material. This enables acquisition of more accurate quantitative data in the subsequent quantitative analysis.

### 1.5 Schematic Operation Example

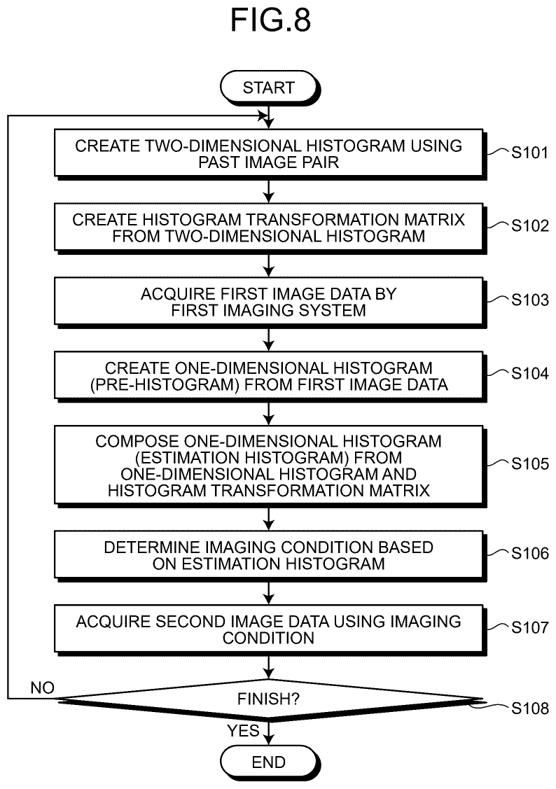

Next, a schematic operation example of the microscopic imaging device 100 according to the present embodiment will be described. FIG. 8 is a flowchart illustrating a schematic operation example of the microscopic imaging device according to the present embodiment. The following description will focus on operations of the control unit 131 and the computation unit 132 in FIG. 7. At that time, the operation related to control may be executed by the control unit 131, and the operation related to computation may be executed by the computation unit 132.

As illustrated in FIG. 8, in the present operation example, by using the accumulated image pair of the first image data acquired by the first imaging system 110 and the second image data acquired by the second imaging system 120 in the past, the computation unit 132 first creates a two-dimensional histogram indicating a correspondence relationship between an occurrence frequency (also simply referred to as a frequency) of each pixel value of the first image data and an occurrence frequency of each pixel value of the second image data (step S101).

Next, the computation unit (creation unit) 132 normalizes the two-dimensional histogram created in step S101 such that the sum of the occurrence frequencies of the respective pixel values of the first image data becomes ‘1’ to create a histogram transformation matrix (step S102).

Next, the control unit 131 drives the first imaging system 110 to perform provisional imaging of the observation sample material (specimen A10), thereby acquiring first image data of the specimen A10 (this may be referred to as third image data to be distinguished from the first image data in step S101) (step S103).

Next, the computation unit 132 creates a one-dimensional histogram (pre-histogram) indicating luminance value distribution of the first image data acquired in step S103 (step S104).

Next, the computation unit (estimation unit) 132 multiplies the histogram transformation matrix created in step S102 and the pre-histogram of the first image data created in step S104 to compose a one-dimensional histogram (estimation histogram) estimating the luminance value distribution of the second image data acquired by the second imaging system 120 (step S105).

Next, the computation unit (determination unit) 132 determines imaging conditions at driving the second imaging system 120 based on the estimation histogram created in step S105 (step S106).

Next, the control unit 131 drives the second imaging system 120 based on the imaging conditions determined in step S106 to acquire second image data of the specimen A10 (the data may also be referred to as fourth image data to be distinguished from the second image data in step S101) (step S107). Thereafter, the control unit 131 determines whether to end the present operation (step S108), and finishes the present operation when it is determined to end (YES in step S108). In contrast, when the present operation is not to be ended (NO in step S108), the present operation returns to step S101, and the subsequent operations are continued.

### 1.6 Detailed Operation Example

Next, details of each step illustrated in FIG. 8 will be described.

### 1.6.1 Creation of Histogram Transformation Matrix

First, “(1) Creation of histogram transformation matrix” illustrated in steps S101 to S102 of FIG. 8 will be described.

### (Step S101)

In step S101 of FIG. 8, an image pair acquired by imaging the sample material of the same type as the observation sample material (specimen A10) is used, among image pairs of the first image data and the second image data acquired in the past respectively using the first imaging system 110 and the second imaging system 120, so as to create a two-dimensional histogram in which the luminance values of the individual pieces of image data are set on two axes.

The biological sample material used at acquisition of the image pair is desirably the same type of tissue specimen as the observation sample material (specimen A10), but need not necessarily be the same type of tissue specimen. In addition, the biological sample material used at acquisition of the image pair is desirably a tissue specimen stained with the fluorescent dye of the same type as the observation sample material, but need not necessarily be a tissue specimen stained with the fluorescent dye of the same type.

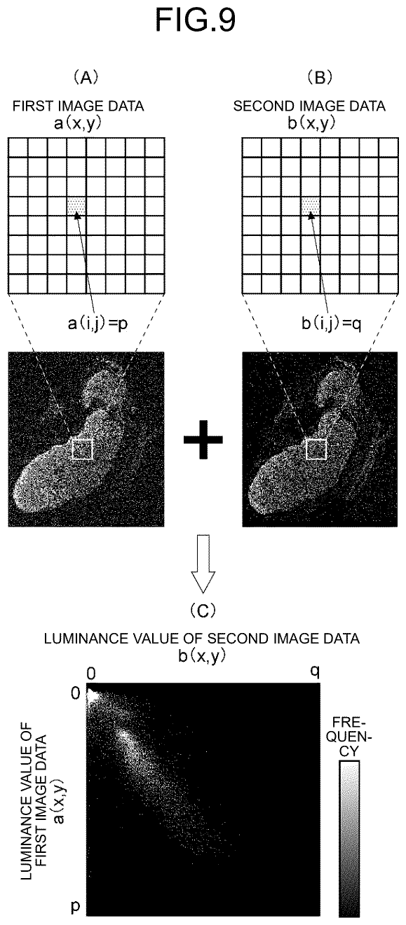

FIG. 9 is a diagram for illustrating a two-dimensional histogram creation example according to the present embodiment. In FIG. 9, (A) illustrates an example of first image data, (B) illustrates an example of second image data, and (C) illustrates an example of a two-dimensional histogram.

As illustrated in FIG. 9, in the two-dimensional histogram (refer to (C)) in which the luminance values of the respective image data acquired by the first imaging system 110 and the second imaging system 120 are set on two axes, the luminance value of the first image data (refer to (A)) acquired by the first imaging system 110 is set on the horizontal axis, and the luminance value of the second image data (refer to (B)) acquired by the second imaging system 120 is set on the vertical axis. Each element in the two-dimensional histogram represents the occurrence frequency (the number of pixels) of the luminance value pair at each coordinate in a case where the same coordinate system is applied to the first image data and the second image data.

When the first image data and the second image data have different resolutions, the two-dimensional histogram may be created after changing the resolutions of the first image data and the second image data to be the same. For example, when the first image data is a low-resolution image and the second image data is a high-resolution image having a higher resolution than the resolution of the first image data, the two-dimensional histogram may be created after the resolution of the second image data is reduced to have the same resolution as the resolution of the first image data, or after the resolution of the first image data is increased to have the same resolution as the resolution of the second image data. The pixel pairs of the first image data and the second image data after the resolution adjustment should have the same number of vertical and horizontal pixels.

At that time, the number of gradations of the first image data and the number of gradations of the second image data may be different from each other, or may be adjusted to be the same.

The co-occurrence relationship of the luminance of the first image data and the second image data constituting the pixel pair as described above is expressed as a histogram, thereby creating the two-dimensional histogram. Here, when first image data a (x, y) indicated in (A) and second image data b (x, y) indicated in (B) are defined and when a luminance value pair at a certain pixel position (i, j) on each image data is (p, q), a two-dimensional histogram h (a, b) indicated in (C) can be expressed by the following Formula (1). In Formula (1), a matrix T is the two-dimensional histogram h (a, b).

$$T = h ( a , b ) = {\sum }_{k = 1}^{pixel} w ( i , j , p , q ) \qquad ( 1 )$$

$$w ( i , j , p , q ) = \{ \begin{matrix}1 : when a ( i , j ) = p ⋂ b ( i , j ) = q \\ 0 : otherwise\end{matrix}$$

### (Step S102)

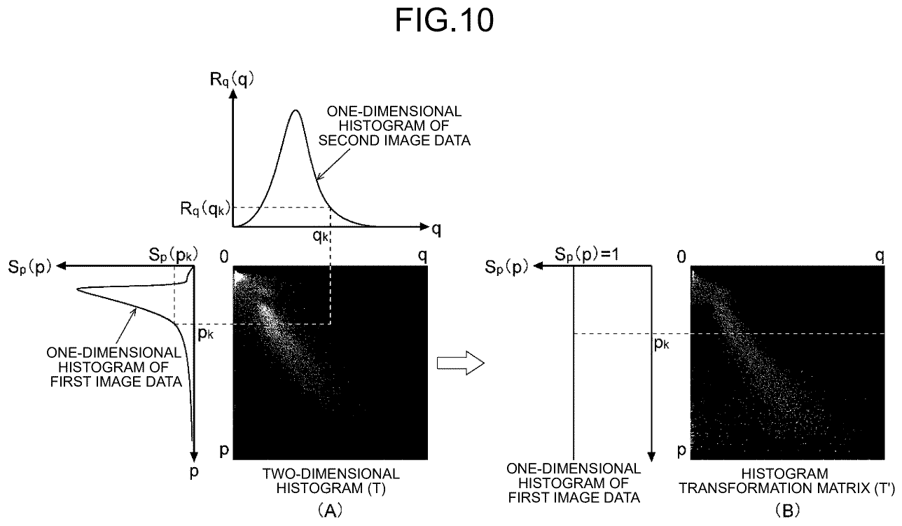

In step S102 of FIG. 8, a histogram transformation matrix is created based on the two-dimensional histogram created in step S101. FIG. 10 is a diagram for illustrating a histogram transformation matrix creation example according to the present embodiment.

Here, the histogram transformation matrix according to the present embodiment may be, for example, a matrix obtained by normalizing the two-dimensional histogram, which has been created from the first image data acquired by the first imaging system 110 and the second image data acquired by the second imaging system 120, such that the sum of the number of pixels for each gradation with respect to the horizontal axis (the luminance value acquired by the first imaging system 110) becomes ‘1’.

Accordingly, in the present embodiment, as in (A) to (B) of FIG. 10 and Formula (2) below, the two-dimensional histogram is normalized such that the sum of frequencies for each gradation on the horizontal axis (P: the luminance value of the first image data) becomes 1 (Sp(P)=1), thereby creating a histogram transformation matrix T′.

$${S}_{p} ( P ) = {\sum }_{k = 0}^{q} ( {T}^{′} ( {p}_{k} ) ) = 1 \qquad ( 2 )$$

$$q : 0 - 255$$

### 1.6.1.1 Modification of Creating Histogram Transformation Matrix

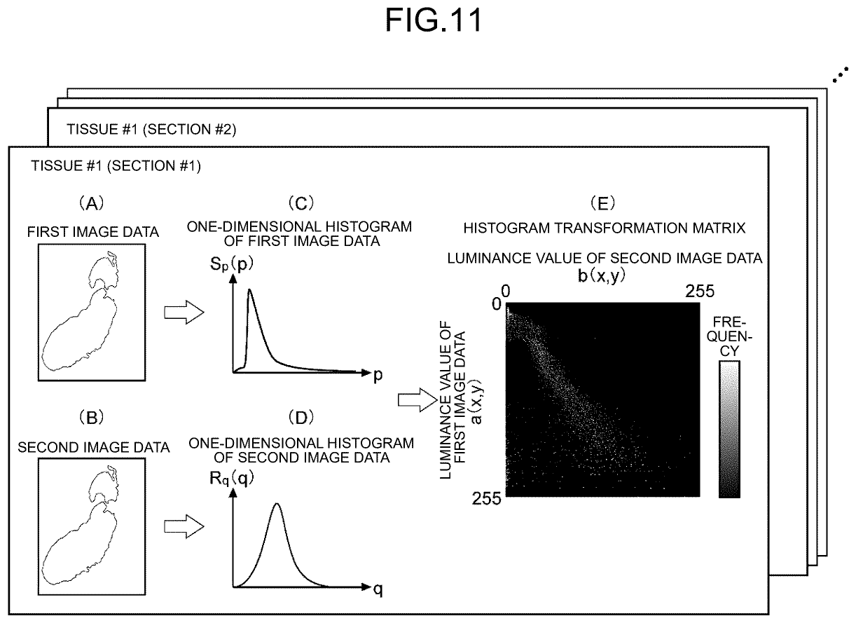

Next, a modification of the above-described histogram transformation matrix creation will be described. FIG. 11 is a diagram for illustrating a modification of the histogram transformation matrix creation example according to the present embodiment. For example, in a case where there is a plurality of image pairs obtained by imaging the same type of sample material among the image pairs captured in the past, as illustrated in FIG. 11, it is also allowable to have a configuration in which the sample materials are divided into one or more groups for each tissue, for example, the histogram transformation matrix (refer to (E)) created from the one-dimensional histograms (refer to (C) and (D)) of each image pair (refer to (A) and (B)) is classified into libraries for each group, and the histogram transformation matrix is optimized in each library.

Incidentally, the sample material of the same type may be, for example, a sample material in which at least one of the following is the same type: the type of the tissue specimen being a sample material; the type of the fluorescent dye used for staining the sample material; and the staining conditions when the sample material is stained. However, the definition is not limited thereto, and the definition of the “sample material of the same type” may be appropriately altered according to the details of analysis.

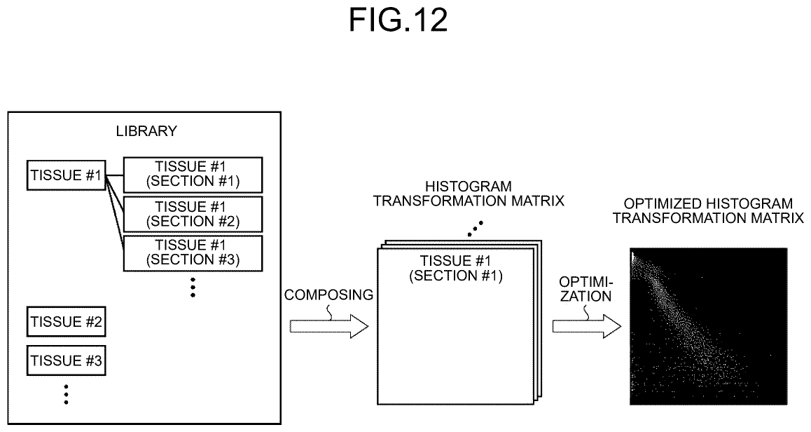

FIG. 12 is a diagram for illustrating optimization of the histogram transformation matrix according to the present embodiment. As illustrated in FIG. 12, in optimization of the histogram transformation matrix, the optimization may be performed using one or more histogram transformation matrices included in each library.

As an optimization method, the following method may be adopted. However, the method is not limited to the method exemplified below, and various methods may be adopted to optimize the histogram transformation matrix.

### (First Method)

For example, the histogram transformation matrix may be optimized by averaging all the histogram transformation matrices in the library.

### (Second Method)

For example, the histogram transformation matrix may be optimized by a method of arranging the histogram transformation matrices in the library in time series according to the creation time of the matrix or the creation time of the image pair used at the time of the creation of the matrix and taking the moving average of the matrices.

### (Third Method)

For example, a histogram transformation matrix optimal for the measurement of the observation sample material (specimen A10) may be automatically extracted from the histogram transformation matrix in the library based on a certain feature or condition. At that time, the automatic extraction of the optimum histogram transformation matrix may utilize machine learning that uses, for example, a trained model trained to output an optimum histogram transformation matrix in response to an input of information related to the specimen A10 (including metadata such as the type of biological sample material and image data acquired by provisional imaging).

### 1.6.2 Estimation of Luminance Value Distribution of Image Acquired by Second Imaging System

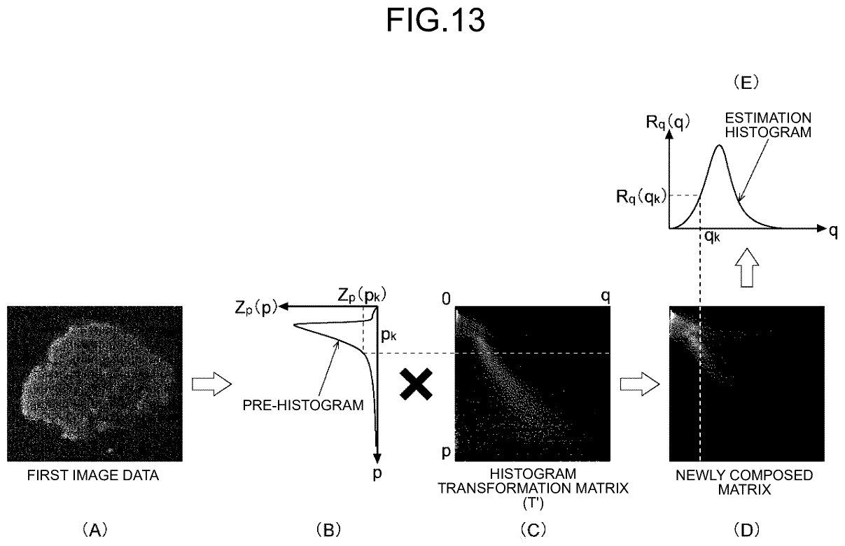

Next, “(2) Estimation of luminance value distribution of image acquired by second imaging system” in steps S103 to S105 of FIG. 8 will be described. FIG. 13 is a diagram for illustrating estimation of luminance value distribution of an image acquired by a second imaging system according to the present embodiment.

### (Step S103)

In step S103 of FIG. 8, provisional imaging of the observation sample material (specimen A10) is performed by the first imaging system 110 to obtain first image data (refer to (A) of FIG. 13).

When the observation sample material is imaged by the first imaging system 110 in step S103, it is desirable that any pixel value of the observation field of view is not saturated, and it is preferable to select an imaging condition that can make maximum use of the signal range detectable by the first detection unit 112. At that time, a condition that gives little damage to the biological sample material is applied as the imaging condition of the first imaging system 110.

For example, by setting the exposure time at the time of provisional imaging to be shorter than the exposure time at the time of main imaging, it is possible to shorten the time during which the biological sample material is irradiated with the excitation light, making it possible to reduce the damage given to the biological sample material and to suppress photobleaching. Furthermore, by setting the excitation light intensity at the time of provisional imaging to an intensity lower than the excitation light intensity at the time of main imaging, for example, it is possible to reduce the damage in the biological sample material exposed to the excitation light, leading to suppression of photobleaching of the biological sample material.

Note that the imaging conditions contributing to reduction of damage to the biological sample material are not limited to the exemplified exposure time and excitation light intensity, and the imaging conditions for provisional imaging may be appropriately adjusted according to the configuration of the first imaging system 110 or the like. Furthermore, in the imaging condition for make maximum use of the signal range without saturating the pixel value, it is also allowable to adjust parameters such as a signal gain and a diaphragm in the first detection unit 112 in addition to the parameters such as the exposure time and the excitation light intensity.

### (Step S104)

In step S104 of FIG. 8, the first image data acquired in step S103 is subjected to image analysis, thereby creating a one-dimensional histogram (pre-histogram) (refer to (B) of FIG. 13) indicating the occurrence frequency (luminance value distribution) of each luminance value of the first image data.

### (Step S105)

In step S105 of FIG. 8, the histogram transformation matrix created in step S102 by the pre-histogram of the first image data created in step S104 (refer to (B) and (C) of FIG. 13) are multiplied to compose an estimation histogram that estimates the luminance value distribution of the second image data to be acquired by the second imaging system 120.

In the calculation of the pre-histogram of the first image data acquired by the first imaging system 110 and the histogram transformation matrix, a product of the pre-histogram of the first image data and the horizontal axis (luminance value of the first image data) direction of the histogram transformation matrix is obtained, leading to composition of a new matrix illustrated in (D) of FIG. 13.

Subsequently, the elements of the newly composed matrix in the vertical axis direction are integrated to compose an estimation histogram (refer to (E) of FIG. 13) that estimates the luminance value distribution of the second image data to be acquired by the second imaging system 120.

The estimation histogram can be expressed as a row vector obtained by integrating, in the vertical axis direction, a matrix obtained by the product of the one-dimensional histogram of the first image data of the observation sample material imaged by the first imaging system 110 and the histogram transformation matrix, as in the following Formula (3).

$${R}_{q} ( q ) = {\sum }_{k = 0}^{p} ( {T}^{′} ( {p}_{k} , {q}_{k} ) \times {Z}_{p} ( {p}_{k} ) \qquad ( 3 )$$

### 1.6.3 Determining Imaging Condition at Imaging Performed by Second Imaging System

Next, “(3) Determining imaging conditions at imaging performed by second imaging system” illustrated in step S106 of FIG. 8 will be described.

### (Step S106)

In step S106 of FIG. 8, imaging conditions in driving the second imaging system 120 are determined based on the estimation histogram created in step S105. Hereinafter, a case of determining the exposure time, which is one of the imaging conditions, based on the estimation histogram will be exemplified.

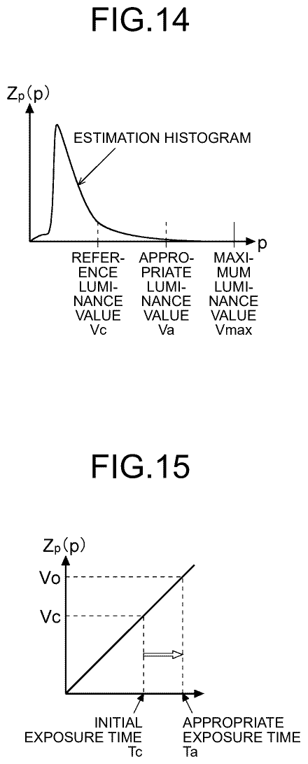

FIG. 14 is a diagram for illustrating a method of determining an exposure time according to the present embodiment. As illustrated in FIG. 14, the present embodiment first determines a reference luminance value Vc to be an index of the luminance value distribution of the estimation histogram. While a method of determining the reference luminance value Vc will be described below, it is allowable to use various values such as, for example, a predetermined percentile value of the whole (for example, 80% percentile value) or a luminance value of a predetermined multiple thereof counted from the lower side of the luminance value p, among all elements in the matrix newly composed by multiplying the pre-histogram and the histogram transformation matrix in step S105 in FIG. 8.

Subsequently, an exposure condition is calculated such that the determined reference luminance value Vc matches or approaches a preset appropriate luminance value Va, for example. The appropriate luminance value Va may be, for example, a luminance value set as an index of the luminance value distribution of the one-dimensional histogram obtained from the ideal second image data, and the appropriate luminance value Va may be a value determined based on an actual measurement value, a simulation, or the like. At this time, the appropriate luminance value Va is preferably a value that can ensure a wide dynamic range of the second detection unit 122 within a range with no saturation of the luminance value of the target region in the observation sample material (that is, the luminance value below the maximum luminance value Vmax.). However, the value is not limited thereto, and the appropriate luminance value Va may be a value arbitrarily determined manually by the user.

FIG. 15 is a diagram illustrating an example of a relationship between an exposure time and a luminance value according to the present embodiment. In FIG. 15, the horizontal axis represents the exposure time, and the vertical axis represents the luminance value. As illustrated in FIG. 15, the luminance value can be regarded as linearly changing in accordance with the change in the exposure time. Therefore, the appropriate exposure time (hereinafter, also referred to as an appropriate exposure time) Ta at the time of main imaging can be calculated by multiplying the exposure time (hereinafter, also referred to as initial exposure time) Tc set in the first imaging system 110 at acquisition of the first image data by a value obtained by dividing the appropriate luminance value Va by the reference luminance value Vc as expressed in the following Formula (4).

$$Ta = Tc \times \frac{Va}{Vc} \qquad ( 4 )$$

In the above Formula (4), the initial exposure time Tc may be an exposure time used in the past main imaging for the same type of tissue specimen. The maximum luminance value Vmax may be used as the appropriate luminance value Va.

The above has described an exemplary case where the exposure condition among the imaging conditions is determined based on the estimation histogram. However, as described above, the imaging condition can include parameters that can change the dynamic range of the second image data, such as the signal gain, the diaphragm, and the excitation light intensity, in addition to the exposure time, and thus at least one of these including the exposure condition may be determined based on the estimation histogram.

### 1.6.4 Method of Determining Reference Luminance Value Vc

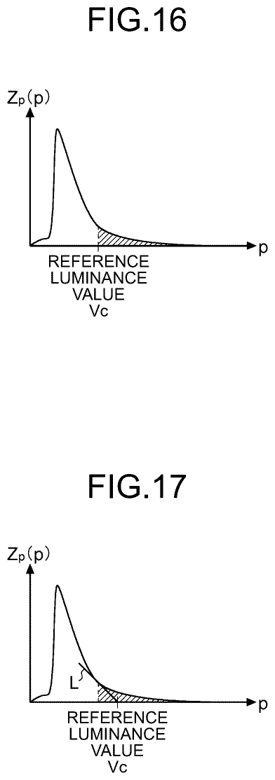

Some examples of the method of determining the reference luminance value Vc in the above description will be described below. FIGS. 16 to 18 are diagrams for illustrating a method of determining the reference luminance value according to the present embodiment.

First, as illustrated in FIG. 16, the reference luminance value Vc may be a predetermined percentile value of the whole or a luminance value of a predetermined multiple thereof counted from the lower side of the luminance value p, among all elements in the matrix newly composed by multiplying the pre-histogram and the histogram transformation matrix in step S105 in FIG. 8.

As illustrated in FIG. 17, the reference luminance value Vc may be a luminance value corresponding to an X intercept of the straight line representing the gradient of the histogram at a certain luminance value. Note that a certain luminance value may be set by using various luminance values such as, for example, a luminance value set in advance by the user, or a predetermined percentile value of the whole counting from the lower luminance value p among all elements in a matrix newly composed by multiplying the pre-histogram and the histogram transformation matrix.

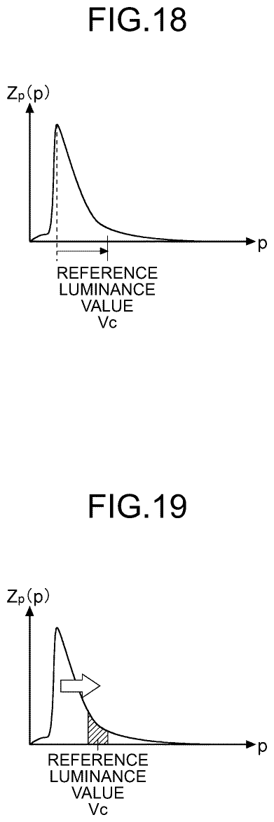

As illustrated in FIG. 18, the reference luminance value Vc may be a luminance value higher by a predetermined % than the luminance value indicating the peak frequency in the estimation histogram.

The exposure condition may be directly determined without determining the reference luminance value Vc. For example, as illustrated in FIG. 19, the exposure condition may be determined so as to maximize the number of elements to be included in the range set in advance with respect to the X axis of the estimation histogram.

### 1.6.5 Signal Gain Adjustment Method

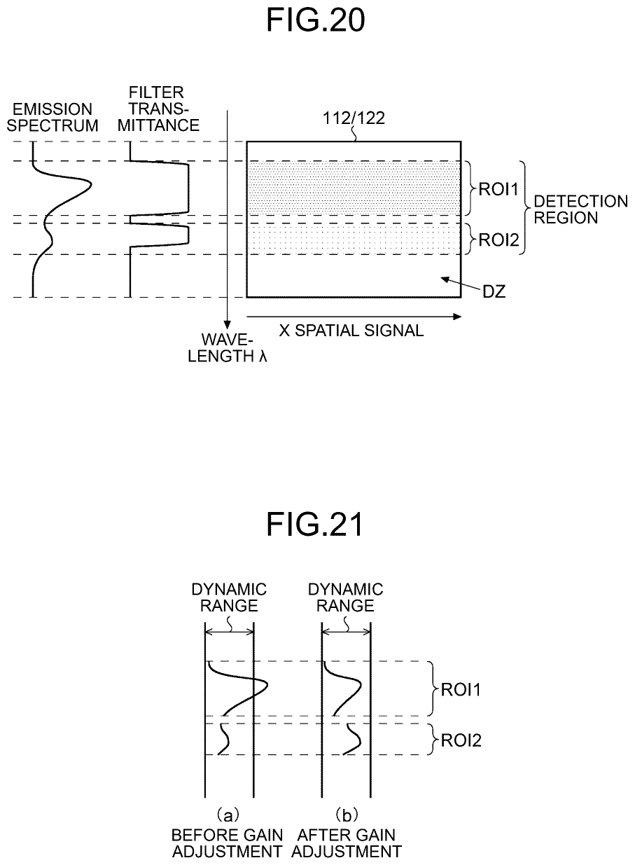

Next, a signal gain adjustment method will be described with an example. FIG. 20 is a schematic diagram illustrating a relationship between each pixel in the first detection unit 112 or the second detection unit 122 and an emission spectrum of an observation target.

As illustrated in FIG. 20, a detection region to be read by the first detection unit 112 or the second detection unit 122 is determined based on a wavelength range of the emission spectrum and a transmission wavelength range of a wavelength filter provided in the first detection unit 112 or the second detection unit 122. In the case of fluorescence imaging, the wavelength filter generally has a band pass characteristic of cutting off excitation light. Therefore, when there is a plurality of excitation wavelengths, there occurs a band (non-transmission band DZ) that does not transmit light as illustrated in FIG. 20. The setting of the detection region excludes such a region that does not include the signal desired to be detected.

As in the example illustrated in FIG. 20, when regions located above and below the non-transmission band DZ are referred to as regions of interest ROI1 and ROI2, respectively, an emission spectrum (hereinafter, also referred to as a fluorescence spectrum) of a color element having a peak corresponding to each region is detected. FIG. 21 is an explanatory diagram illustrating the relationship between the emission spectrum and the dynamic range in the detection region, in which (a) illustrates an example of data acquired before gain adjustment (signal gains are the same in each detection region), and (b) illustrates an example of data acquired after gain adjustment.

As illustrated in (a) of FIG. 21, the color element in the region of interest ROI1 has a strong spectral intensity and the signal saturates beyond the dynamic range, while the color element in the region of interest ROI2 has a weak intensity and the signal does not saturate. Accordingly, in the present embodiment, as illustrated in (b) of FIG. 21, the signal gain of the (X, λ) region corresponding to the region of interest ROI1 is set to be relatively low, and the signal gain of the (X, λ) region corresponding to the region of interest ROI2 is set to be relatively high. As a result, both dark and bright color elements can be imaged by suitable exposure.

Also by setting the exposure time of the (X, λ) region corresponding to the region of interest ROI1 to be relatively short and setting the exposure time of the (X, λ) region corresponding to the region of interest ROI2 to be relatively long, it is possible to image both a dark color element and a bright color element by suitable exposure, similarly to the gain adjustment.

### 1.7 Specific Example

Next, a specific example of the imaging condition determination operation according to the present embodiment will be described with reference to the drawings.

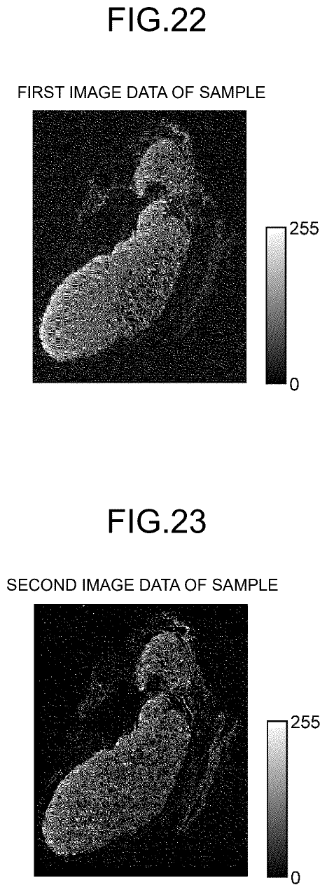

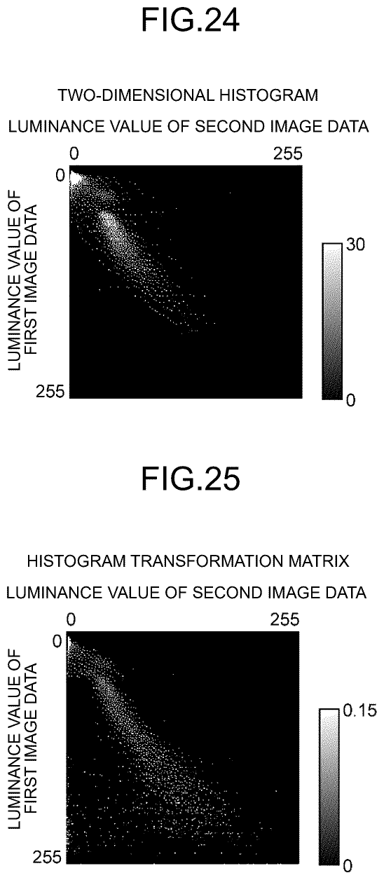

FIGS. 22 to 25 are diagrams illustrating a flow of “(1) Creation of histogram transformation matrix” in a specific example of the imaging condition determination operation according to the present embodiment. FIG. 22 is an example of first image data acquired by the first imaging system 110 by performing provisional imaging of a section specimen (also referred to as a sample) of a tonsil tissue block different from the observation sample material. FIG. 23 is an example of second image data acquired by the second imaging system 120 by performing main imaging of the same sample as the provisional imaging. In the provisional imaging using the first imaging system 110, LED illumination beam in the ultraviolet wavelength region is emitted from the rear portion of the glass slide on which the sample is placed, and the entire sample is imaged at a low magnification. In the main imaging using the second imaging system 120, a laser beam having an excitation wavelength of 405 nm (nanometer) is emitted onto the front portion of the sample, and a region imaged by the first imaging system 110 is imaged at a high magnification. FIG. 24 is an example of a two-dimensional histogram created using the first image data illustrated in FIG. 22 and the second image data illustrated in FIG. 23. FIG. 25 is an example of a histogram transformation matrix created by normalizing the sum of frequencies for each gradation on the horizontal axis (luminance value of the first image data) of the two-dimensional histogram illustrated in FIG. 24 to be ‘1’.

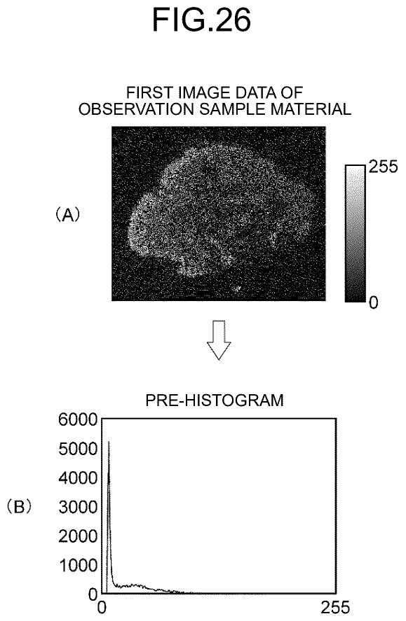

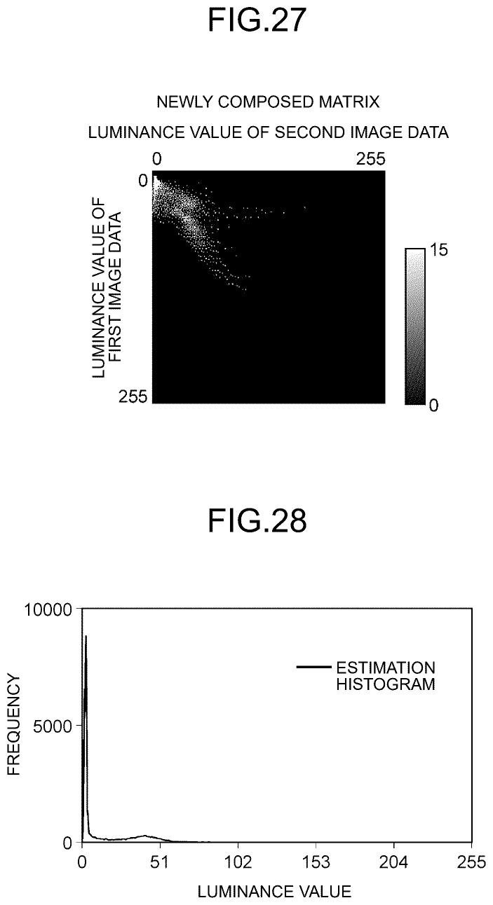

FIGS. 26 to 28 are diagrams each illustrating a flow of “(2) Estimation of luminance value distribution of image acquired by second imaging system” in a specific example of the imaging condition determination operation according to the present embodiment. (A) of FIG. 26 is an image obtained by imaging an observation sample material stained using the fluorescent dye DAPI (4′, 6-diamidino-2-phenylindole), and (B) of FIG. 26 is a diagram illustrating a one-dimensional histogram (pre-histogram) of the first image data indicated in (A) of FIG. 26. In the present specific example, the observation sample material is a tissue block section of a lymph node tissue. Similarly to the provisional imaging of the sample, the provisional imaging using the first imaging system 110 is performed by emitting LED illumination beams in the ultraviolet wavelength region from the rear portion of the glass slide on which the observation sample material is placed so as to image the entire sample material at a low magnification. FIG. 27 is an example of a matrix newly composed by the product of the histogram transformation matrix illustrated in FIG. 25 and the one-dimensional histogram of the first image data obtained by imaging the observation sample material illustrated in (B) of FIG. 26(B). FIG. 28 is an example of an estimation histogram obtained by integrating the elements of the matrix illustrated in FIG. 27 in the vertical axis direction.

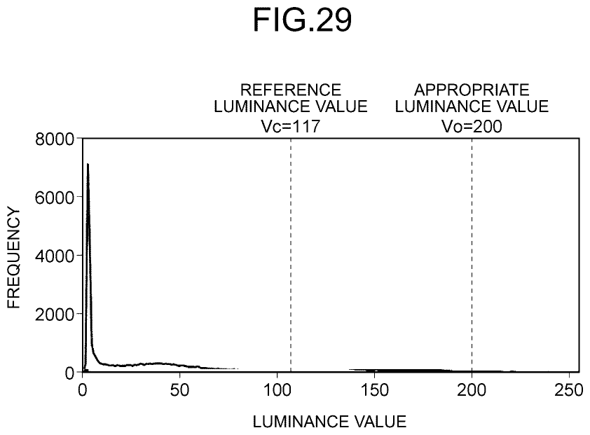

FIG. 29 is a diagram illustrating a flow of “(3) Determination of imaging condition in performing imaging in second imaging system” in a specific example of the imaging condition determination operation according to the present embodiment. FIG. 29 illustrates the reference luminance value Vc and the appropriate luminance value Va with respect to the estimation histogram illustrated in FIG. 28. In the present example, the reference luminance value Vc is assumed to be a value determined by the determination method described above with reference to FIG. 16. Specifically, the reference luminance value Vc is set to a luminance value (Vc=117), which is three times the 80% percentile value (=39) of the whole counted from the lower side of the luminance value p, among all elements in the matrix newly composed by multiplying the pre-histogram and the histogram transformation matrix.

Here, when the initial exposure time Tc is 684 microseconds (μs) and the appropriate luminance value Va is about 80% (Va=200) of the dynamic range (0 to 255) of the luminance value, the appropriate exposure time Ta obtained from the reference luminance value Vc is 1.169 μs as indicated in the following Formula (5).

$$Ta = Tc \times \frac{Va}{Vc} = 684 \times \frac{200}{117} = 1.169 [ μs ] \qquad ( 5 )$$

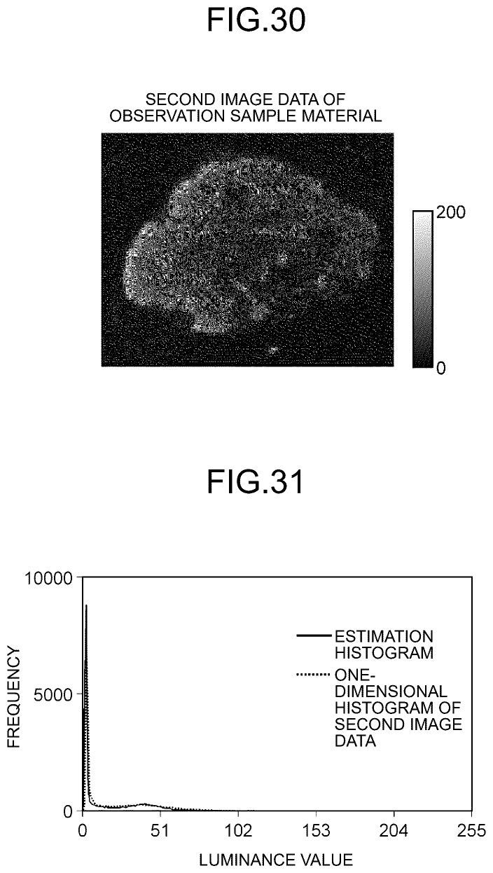

FIG. 30 is an example of the second image data of the observation sample material acquired by performing the main imaging using the initial exposure time (684 μs) according to the present embodiment. FIG. 31 is a diagram for comparing the estimation histogram illustrated in FIG. 28 with the one-dimensional histogram of the second image data illustrated in FIG. 30.

As illustrated in FIG. 30, the main imaging of the observation sample material is performed using the imaging condition determined by the imaging condition determination operation according to the present embodiment, making it possible to acquire the second image data with satisfactory image quality. As illustrated in FIG. 31, the one-dimensional histogram of the second image data substantially matches the estimation histogram.

The appropriate exposure time calculated, as a value, from the one-dimensional histogram of the second image data in FIG. 31 is 991 μs. This value is close to the appropriate exposure time Ta (=1.169 μs) calculated from the estimation histogram, indicating that an appropriate imaging condition can be calculated based on the estimation histogram.

The above has described the exemplary case where the second image data of the entire observation sample material is acquired using one imaging condition at the time of main imaging. The configuration is not limited thereto and the observation sample material may be divided into a plurality of regions, and the imaging condition may be set independently for each region, for example.

### 2. Second Embodiment

Next, a second embodiment of the present disclosure will be described in detail with reference to the drawings. In the following description, the configuration, operation, and effects similar to those of the above-described embodiments will be cited, thereby omitting redundant description.

The first embodiment above has described the exemplary case where main imaging is performed using the imaging condition obtained based on the first image data acquired in the provisional imaging of the observation sample material. However, the configuration is not limited thereto. The second embodiment will describe an exemplary case where test imaging by the second imaging system 120 is executed in the microscopic imaging device 100 according to the first embodiment by using an imaging condition obtained based on the first image data acquired in the provisional imaging, and a more appropriate imaging condition is determined based on the image data acquired in test imaging.

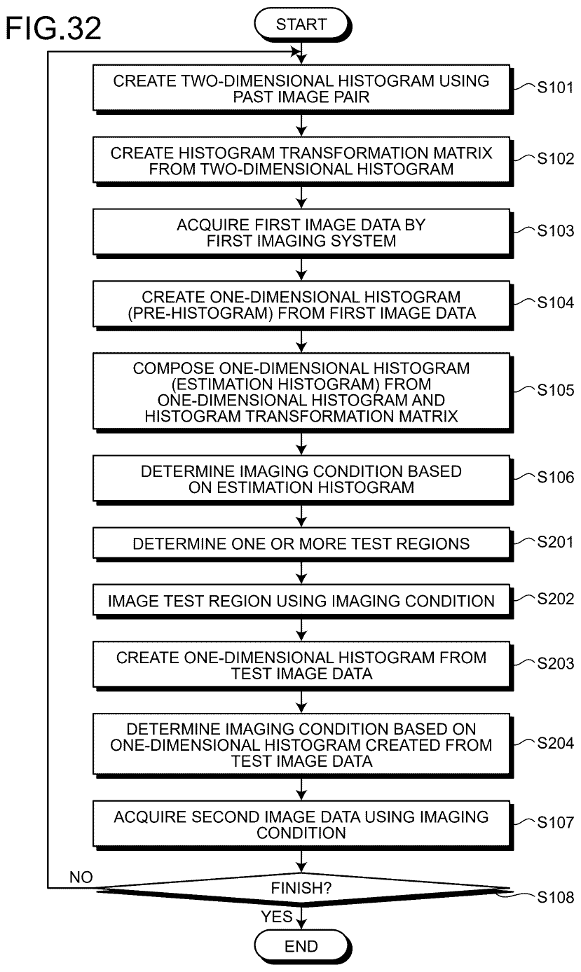

FIG. 32 is a flowchart illustrating an operation example of a microscopic imaging device according to the present embodiment. The following description will focus on operations of the control unit 131 and the computation unit 132, similarly to FIG. 8. Steps similar to those in FIG. 8 are denoted by the same reference numerals, and redundant description is omitted.

As illustrated in FIG. 32, in the present operation, similarly to steps S101 to S106 in FIG. 8, the pre-histogram of the first image data obtained by the provisional imaging by the histogram transformation matrix are multiplied to compose an estimation histogram, and imaging conditions are determined based on the composed estimation histogram.

Next, the control unit 131 determines one or more partial regions in the observation sample material as a region (test region) to be subjected to test imaging (step S201).

Next, the control unit 131 performs test imaging of the test region determined in step S201 using the second imaging system 120 (step S202). At that time, the control unit 131 may drive the second imaging system 120 under the imaging conditions determined in step S106. In addition, the region irradiated with the excitation light by the second light source unit 121 may be the entire observation sample material or a partial region including the test region in the observation sample material.

Next, the computation unit 132 creates a one-dimensional histogram (test image histogram) indicating the luminance value distribution of the image data (test image data) acquired by the test imaging (step S203). At that time, the test image data may be converted so that its resolution and size match those of the second image data.

Next, the computation unit 132 determines final imaging conditions for driving the second imaging system 120 based on the one-dimensional histogram of the test image data created in step S203 (step S204). The operation of determining the final imaging conditions based on the one-dimensional histogram of the test image may be, for example, an operation similar to the operation indicated in step S106.

Thereafter, similarly to steps S107 to S108 in FIG. 8, the main imaging is executed using the imaging conditions determined in step S204 to acquire the second image data, so as to finish the present operation.

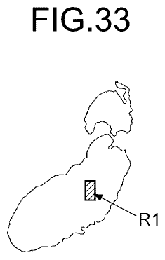

FIG. 33 is a diagram illustrating an example of a test region according to the present embodiment. In the present embodiment, the test region R1 to be subjected to test imaging may be a region having a small influence on the quantitative analysis of the second image data even when the observation target is damaged by the test imaging. Examples of such a test region R1 include the following regions. Incidentally, the test region R1 may be a region having a fixed size, or may be, for example, a region partitioned by image segmentation of the first image data.
(1) Partial region where average of luminance values is maximum on observation sample material
(2) Partial region where the mode of the luminance value on the observation sample material is equal or closest to a predetermined luminance value
(3) Partial region where the average of the luminance values on the observation sample material is equal or closest to the average of the luminance values of the entire observation sample material
(4) Partial region set by user for observation sample material

As described above, according to the present embodiment, it is possible to determine a further optimized imaging condition as an imaging condition at the time of main imaging based on test image data acquired in test imaging. In addition, by setting a region having a small influence on the quantitative analysis of the second image data even when the observation target is damaged in the test region to be subjected to test imaging, it is possible to minimize the influence, at the time of the quantitative analysis, on the second image data obtained by the main imaging. Furthermore, since the imaging condition at the time of test imaging is determined using the first image data acquired in the provisional imaging, it is possible to perform test imaging with the minimum required exposure time and excitation light intensity. This also makes it possible to minimize the damage to the observation sample material caused by the test imaging.

Since other configurations, operations, and effects may be similar to those in the above-described embodiment, detailed description will be omitted here.

### 2.1 Modification

Next, a modification of the operation example described above with reference to FIG. 32 will be described. The following description will focus on operations of the control unit 131 and the computation unit 132, similarly to FIGS. 8 and 32. Steps similar to those in FIG. 32 are denoted by the same reference numerals, and redundant description is omitted.

### 2.1.1 First Modification

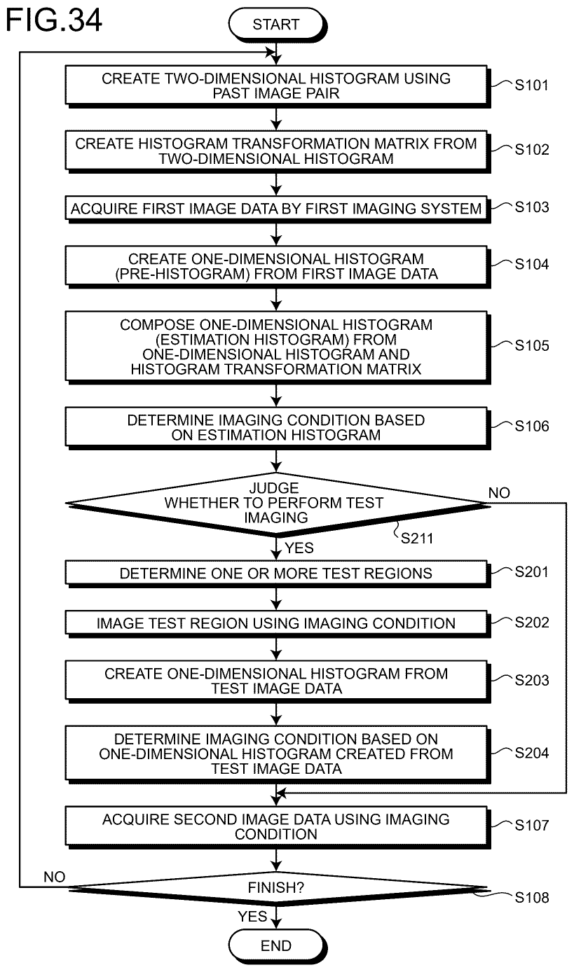

FIG. 34 is a flowchart illustrating an operation example of a microscopic imaging device according to a first modification of the present embodiment. As illustrated in FIG. 34, the present operation includes operations similar to the operation example illustrated in FIG. 32, except for addition of step S211 in which the control unit 131 judges whether to execute test imaging, after step S106, that is, before the operation of executing test imaging.

The judgment as to whether to execute test imaging in step S211 may be executed based on, for example, the estimation histogram composed in step S105, the imaging condition determined in step S106, and the like. For example, it is also allowable to have a configuration in which a judgment criterion is set based on an estimation histogram or an imaging condition created at the time of past imaging, and the control unit 131 judges whether to execute test imaging based on this criterion. However, the configuration is not limited thereto and allows various alterations, for example, the user may set a judgment criterion.

Other operations may be similar to the operations described above with reference to FIG. 32.

### 2.1.2 Second Modification

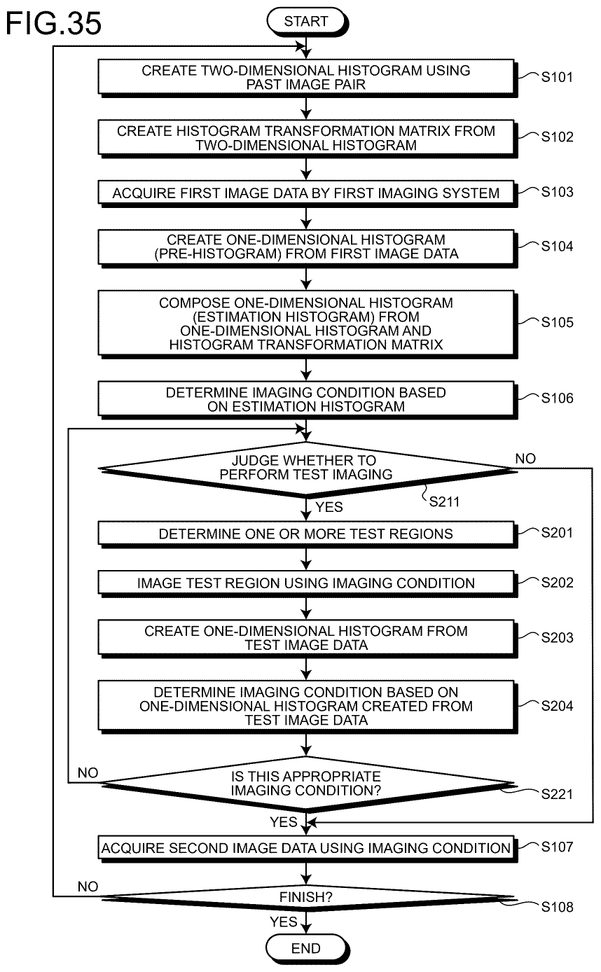

FIG. 35 is a flowchart illustrating an operation example of a microscopic imaging device according to a second modification of the present embodiment. As illustrated in FIG. 35, the present operation includes operations similar to the operation example illustrated in FIG. 34, except for addition of step S221 before step S107, that is, when the imaging condition is determined based on the one-dimensional histogram obtained by the test imaging, the new step causes the control unit 131 to judge whether the determined imaging condition is an appropriate imaging condition.

The determination as to whether the imaging condition is appropriate in step S221 may be performed with a configuration in which, for example, a judgment criterion is set based on the imaging condition determined at the time of past imaging, and the control unit 131 judges whether the imaging condition is appropriate based on this criterion. However, the configuration is not limited thereto and allows various alterations, for example, the user may set a judgment criterion.

Other operations may be similar to the operations described above with reference to FIG. 34.

### 3. Third Embodiment

Next, a third embodiment of the present disclosure will be described in detail with reference to the drawings. In the following description, the configuration, operation, and effects similar to those of the above-described embodiments will be cited, thereby omitting redundant description.

The first and second embodiments above have described the exemplary cases where the imaging condition is automatically determined from the estimation histogram. However, the configuration is not limited thereto. The third embodiment will describe an exemplary case where a Graphical User Interface (GUI) for manually adjusting the imaging condition is provided to the user, and the main imaging is performed using the imaging condition adjusted by the user using the GUI.

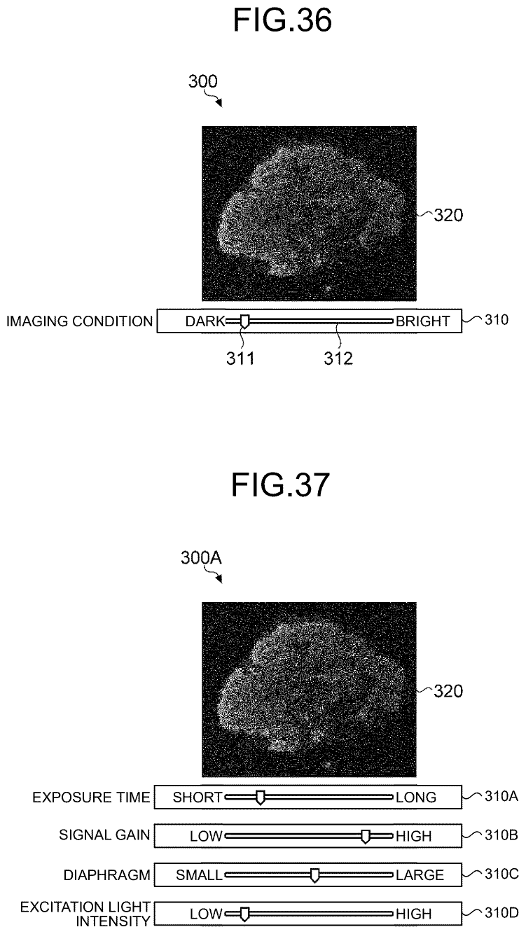

FIGS. 36 and 37 are diagrams illustrating an example of an imaging condition adjustment GUI according to the present embodiment. As illustrated in FIG. 36, the imaging condition adjustment GUI 300 includes an imaging condition adjustment unit 310 and a reference image display unit 320.

The imaging condition adjustment unit 310 includes, for example, a slider 311 and a slider bar 312. The user can adjust the imaging conditions by moving the slider 311 along the slider bar 312 using an input device such as a mouse or a touch panel. In the example illustrated in FIG. 36, the second image data acquired in the main imaging becomes darker as the slider 311 is moved leftward, and the second image data becomes brighter as the slider 311 is moved rightward. However, the configuration of the imaging condition adjustment unit 310 is not limited to the slider 311 and the slider bar 312, and may be variously modified such as the use of a radio button for selecting a specific setting value or a numerical value input to a box.

The imaging condition adjustment unit may be provided in a manner such that one imaging condition adjustment unit 310 is provided for the entire imaging condition as in an imaging condition adjustment GUI 300 illustrated in FIG. 36, or that each of imaging condition adjustment units 310A to 310D is provided for each imaging condition as in an imaging condition adjustment GUI 300A illustrated in FIG. 37. Alternatively, one imaging condition adjustment unit may be provided for a set of two or more parameters (for example, a set of an exposure time and a signal gain) in the imaging conditions.

In a case where one imaging condition adjustment unit 310 is provided for the entire imaging conditions or in a case where one imaging condition adjustment unit is provided for a set of two or more parameters, among parameters to be adjusted in the imaging conditions, a parameter that causes less damage to the observation sample material may be preferentially adjusted. For example, in the case of the imaging conditions of “signal gain”, “diaphragm”, “exposure time”, and “excitation light intensity”, and when the damage given to the observation sample material increases in the order of “signal gain”< “diaphragm”< “exposure time”< “excitation light intensity”, the value may be preferentially adjusted in the order of “signal gain”, “diaphragm”, “exposure time”, and “excitation light intensity”.

In addition, a predicted image of the second image data predicted to be acquired when main imaging is performed under an imaging condition adjusted by the user moving the slider 311 may be displayed as a reference image on the reference image display unit 320.

The reference image may be an image generated by converting each pixel value of the first image data captured by the first imaging system 110 into a luminance value estimated to be acquired by the second imaging system 120. Furthermore, the luminance value of each pixel of the reference image may linearly change with the change in the imaging condition using the imaging condition adjustment unit 310.

In this manner, by sequentially presenting, to the user, the reference image of the second image data that will be acquired under the imaging condition under adjustment, the user can adjust the imaging condition while performing visual confirmation. This makes it possible to manually set more appropriate imaging conditions.

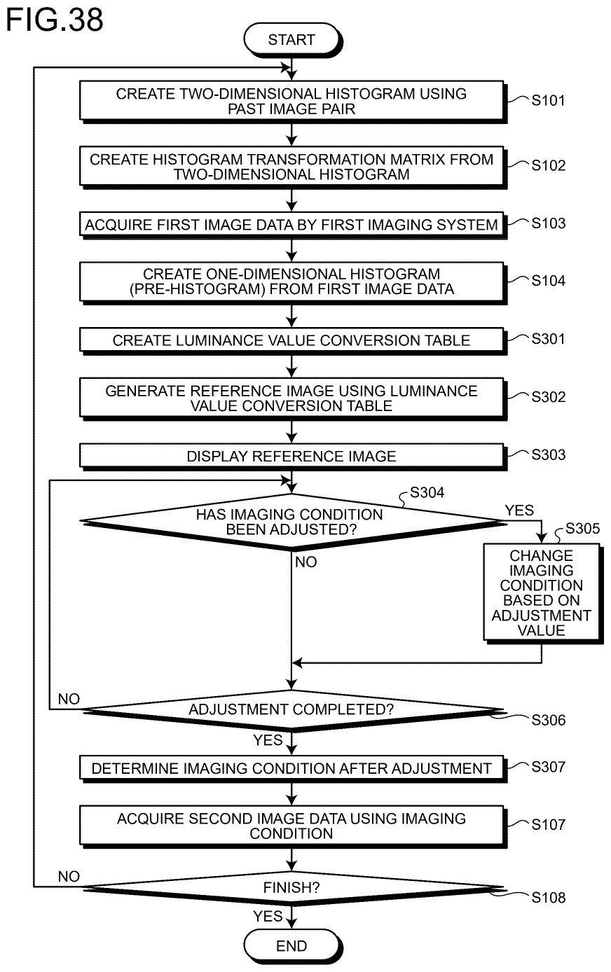

FIG. 38 is a flowchart illustrating an operation example of a microscopic imaging device according to the present embodiment. The following description will focus on operations of the control unit 131 and the computation unit 132, similarly to FIGS. 8 and 32. Steps similar to those in FIG. 8 or 32 are denoted by the same reference numerals, and redundant description is omitted. FIG. 38 illustrates an exemplary case where the operation flow illustrated in FIG. 8 is used as a base, but the flow is not limited thereto, and the operation flow illustrated in FIG. 32 may be used as a base.

As illustrated in FIG. 38, in this operation, similarly to steps S101 to S104 in FIG. 8, a pre-histogram is created from the first image data acquired by performing provisional imaging of the observation sample material.

Next, the computation unit 132 creates a luminance value conversion table for converting each luminance value of the first image data of the observation sample material acquired in step S103 into a luminance value of each pixel of the second image data estimated to be acquired by the second imaging system 120 (step S301). This luminance value conversion table uses, for example, an average value in the luminance value direction of the first imaging system 110 from a matrix newly composed by multiplying the pre-histogram created in step S102 by the histogram transformation matrix created in step S102, and allocates the calculated average value to the luminance values 0 to 255 of the first imaging system data.

Next, the computation unit (generation unit) 132 converts the luminance value of each pixel of the first image data acquired in step S103 based on the luminance value conversion table, thereby generating a reference image to be presented to the user (step S302). The generated reference image is displayed on the reference image display unit 320 of the imaging condition adjustment GUI 300 (which may be the imaging condition adjustment GUI 300A) (step S303).

Next, the control unit 131 determines whether the user has adjusted the imaging condition using the imaging condition adjustment unit 310 of the imaging condition adjustment GUI 300 (step S304). In a case where the imaging condition has not been adjusted (NO in step S304), the processing proceeds to step S306.

In contrast, when the imaging condition has been adjusted (YES in step S304), the computation unit 132 changes the imaging condition based on the adjustment amount input using the imaging condition adjustment unit 310 (step S305), and the processing proceeds to step S306.

In step S306, the control unit 131 determines whether the adjustment of the imaging condition using the imaging condition adjustment GUI 300 has been completed. When the adjustment is not completed (NO in step S306), this operation returns to step S304, and the subsequent operations are repeated.

In contrast, when the adjustment is completed (YES in step S306), the control unit 131 determines the adjusted imaging condition as the imaging condition for main imaging (step S307). Then, similarly to steps S107 to S108 in FIG. 8, the control unit 131 executes main imaging using the imaging condition determined in step S307 to acquire the second image data, and finishes the present operation.

### 3.1 Specific Example

Next, a specific example of the reference image generation operation according to the present embodiment will be described with reference to the drawings.

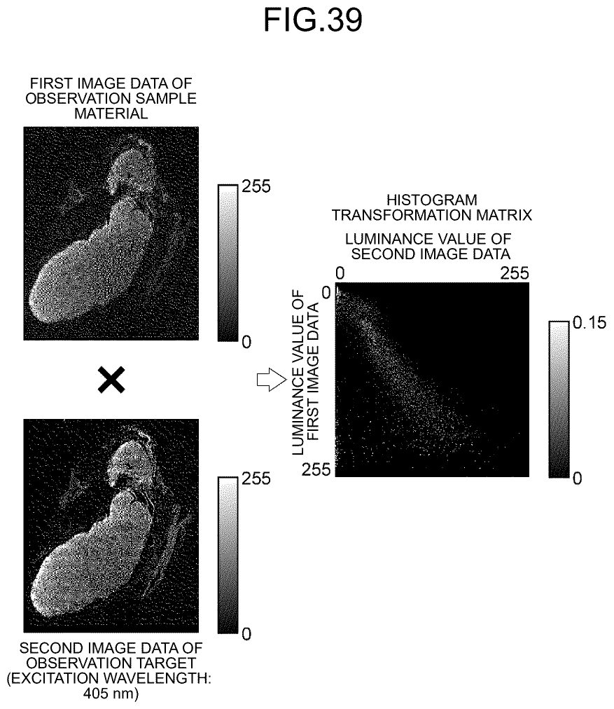

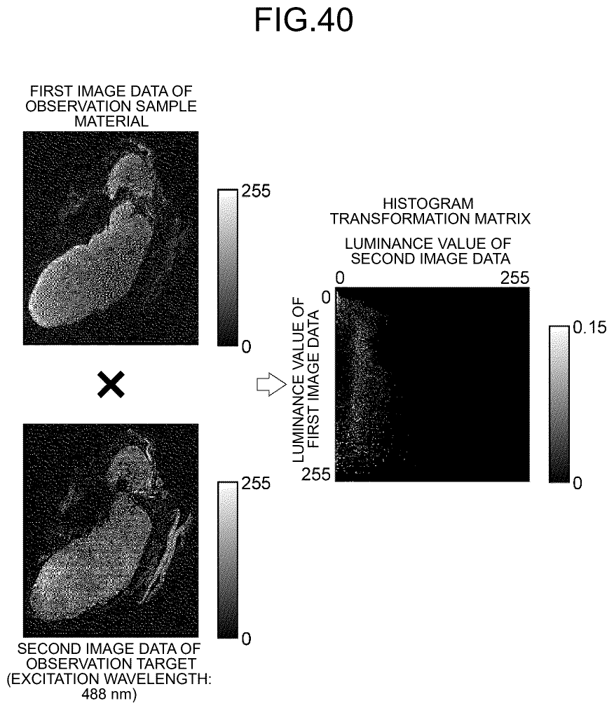

FIGS. 39 and 40 are diagrams illustrating a flow up to Creation of a histogram transformation matrix in a specific example of the reference image generation operation according to the present embodiment. FIGS. 39 and 40 each is an example including: first image data acquired by performing provisional imaging of a sample different from the observation sample material by the first imaging system 110; second image data acquired by performing main imaging of the same sample by the second imaging system 120; and a histogram transformation matrix created from the first image data and the second image data. In the examples individually illustrated in FIGS. 39 and 40, the provisional imaging using the first imaging system 110 emits LED illumination beams in the ultraviolet wavelength region from the rear portion of the glass slide on which the sample is placed to image the entire sample at a low magnification; the main imaging using the second imaging system 120 emits laser beam of a predetermined excitation wavelength to the front portion of the sample to perform high magnification imaging on a region having been imaged by the first imaging system 110. The example illustrated in FIG. 39 is a case where the sample is irradiated with a laser beam having an excitation wavelength of 405 nm, while the example illustrated in FIG. 40 is a case where the sample is irradiated with a laser beam having an excitation wavelength of 488 nm.

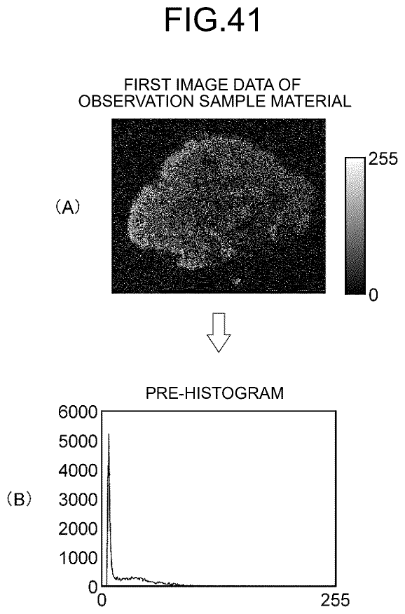

FIG. 41 is a diagram illustrating a flow from provisional imaging of an observation sample material to generation of a pre-histogram in a specific example of the reference image generation operation according to the present embodiment. The example illustrated in FIG. 41 may be similar to the example described above with reference to FIG. 26, and thus a detailed description thereof will be omitted here.

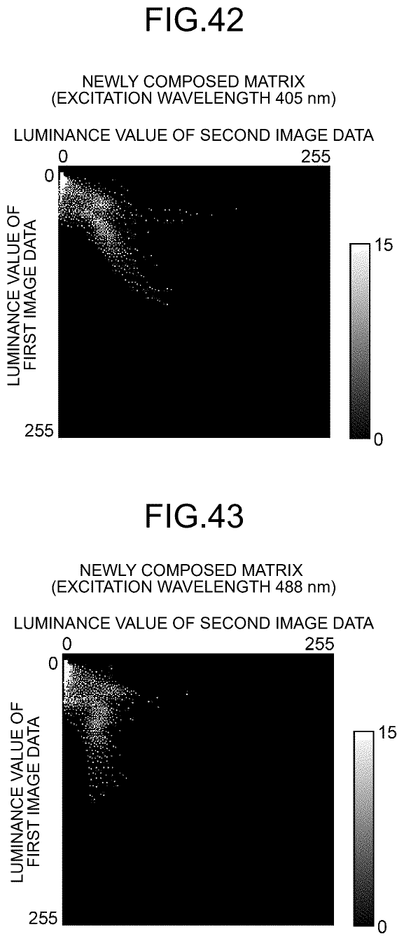

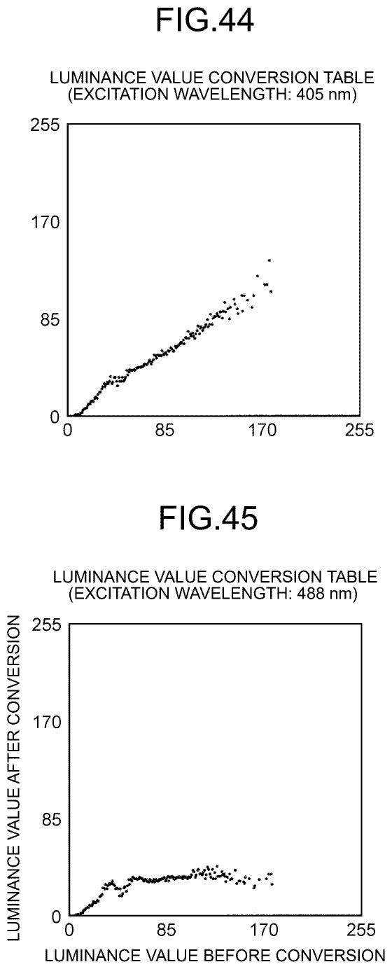

FIGS. 42 to 45 are diagrams illustrating a flow up to creation of a luminance value conversion table in a specific example of the reference image generation operation according to the present embodiment. FIG. 42 is an example of a matrix newly composed by the product of the histogram transformation matrix illustrated in FIG. 39 and the pre-histogram of the observation sample material illustrated in FIG. 41. FIG. 31 is an example of a matrix newly composed by the product of the histogram transformation matrix illustrated in FIG. 40 and the pre-histogram of the observation sample material illustrated in FIG. 41. Furthermore, FIG. 44 is an example of a luminance value conversion table created from the matrix illustrated in FIG. 42;

FIG. 45 is an example of a luminance value conversion table created from the matrix illustrated in FIG. 43. The luminance values in the luminance value conversion tables after conversion illustrated in FIGS. 44 and 45 may be average values in the horizontal axis (luminance value of the first imaging system 110) direction of the matrix illustrated in FIGS. 42 and 43, respectively.

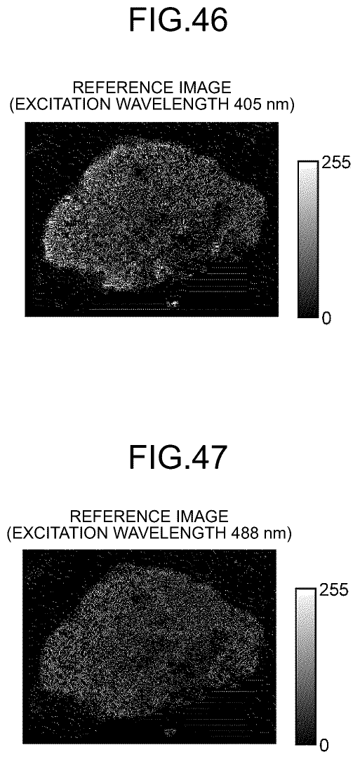

FIGS. 46 and 47 are diagrams illustrating examples of a reference image generated by a specific example of the reference image generation operation according to the present embodiment. FIG. 46 illustrates an example of a reference image generated by converting the first image data of the observation sample material illustrated in FIG. 41 using the luminance value conversion table illustrated in FIG. 44. FIG. 47 illustrates an example of a reference image generated by converting the first image data of the observation sample material illustrated in FIG. 41 using the luminance value conversion table illustrated in FIG. 45.

In the present embodiment, when the user adjusts the imaging condition using the imaging condition adjustment unit 310 of the imaging condition adjustment GUI 300, the brightness of the reference image (refer to FIG. 46 or 47) displayed on the reference image display unit 320 of the imaging condition adjustment GUI 300 is adjusted based on the adjustment value or the adjusted imaging condition.

As described above, according to the present embodiment, the user can adjust the imaging condition while referring to the predicted image (reference image) of the second image data to be acquired by the main imaging. This enables main imaging to be performed under more appropriate imaging conditions, leading to improvement of the accuracy of quantitative analysis for the second image data.

Since other configurations, operations, and effects may be similar to those in the above-described embodiment, detailed description will be omitted here.

### 4. Fourth Embodiment

Next, a fourth embodiment of the present disclosure will be described in detail with reference to the drawings. In the following description, the configuration, operation, and effects similar to those of the above-described embodiments will be cited, thereby omitting redundant description.

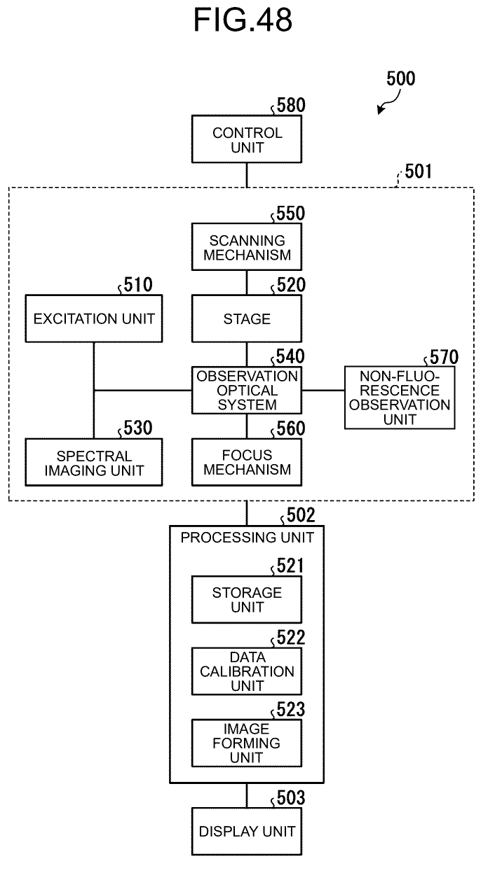

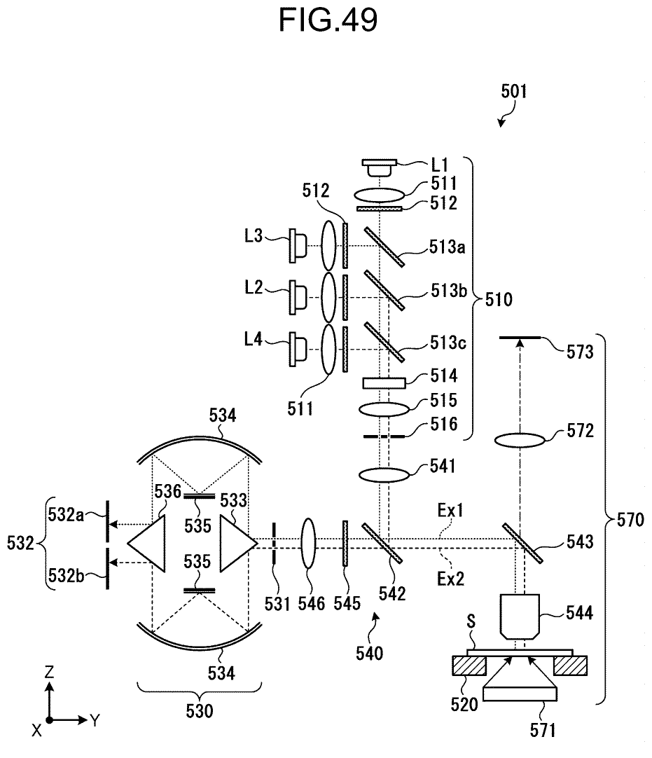

The diagnosis support system 1 according to the above-described embodiment can also be applied to a fluorescence observation device as exemplified below. The above information processing system can be applied to, for example, a fluorescence observation device 500. The fluorescence observation device 500 is an example of a microscope system. Hereinafter, a configuration example of the fluorescence observation device 500 will be described with reference to FIGS. 48 and 49. FIG. 48 is a diagram illustrating an example of a schematic configuration of the fluorescence observation device 500 according to the present embodiment. FIG. 49 is a diagram illustrating an example of a schematic configuration of an observation unit 501 according to the present embodiment.

As illustrated in FIG. 48, the fluorescence observation device 500 includes an observation unit 501, a processing unit 502, and a display unit 503.

The observation unit 501 includes an excitation unit (irradiation unit) 510, a stage 520, a spectral imaging unit 530, an observation optical system 540, a scanning mechanism 550, a focus mechanism 560, and a non-fluorescence observation unit 570.

The excitation unit 510 irradiates the observation target with a plurality of irradiation light beams having different wavelengths. For example, the excitation unit 510 irradiates a pathological specimen, that is, a pathological sample, which is an observation target, with a plurality of line illumination beams having different wavelengths emitted non-axially in parallel. The stage 520 is a table that supports the pathological specimen, and is movable by the scanning mechanism 550 in a direction perpendicular to the direction of the line beam emitted as line illumination. The spectral imaging unit 530 includes a spectroscope and acquires a fluorescence spectrum, namely, spectral data, of the pathological specimen excited in a line shape by line illumination.

That is, the observation unit 501 functions as a line spectroscope that acquires spectral data corresponding to the line illumination beam. In addition, the observation unit 501 also functions as an imaging device that captures, for each line, a plurality of fluorescence images generated by a pathological specimen being an imaging target for each of a plurality of fluorescence wavelengths and acquires data of the plurality of captured fluorescence images in order of arrangement of the lines.

Here, non-axial arrangement in parallel indicates the state including a plurality of line illumination beams arranged non-axially and in parallel. The state of non-axial means that the illumination beams are not coaxial, with a distance between the axes not particularly limited. The term “parallel” is not limited to parallel in a strict sense, and includes a state of being substantially parallel. For example, the term permits distortion originated from an optical system such as a lens or deviation from a parallel state due to manufacturing tolerance, and the cases of these are also regarded as parallel.

The excitation unit 510 and the spectral imaging unit 530 are connected to the stage 520 via the observation optical system 540. The observation optical system 540 has a function of optimum focus tracking by using the focus mechanism 560. The observation optical system 540 may be connected to a non-fluorescence observation unit 570 for dark field observation, bright field observation, or the like. Furthermore, the observation unit 501 may be connected to a control unit 580 that controls the excitation unit 510, the spectral imaging unit 530, the scanning mechanism 550, the focus mechanism 560, the non-fluorescence observation unit 570, and the like.

The processing unit 502 includes a storage unit 521, a data calibration unit 522, and an image forming unit 523. Based on the fluorescence spectrum of the pathological specimen acquired by the observation unit 501, the processing unit 502 typically forms an image of the pathological specimen or outputs a distribution of the fluorescence spectrum. Hereinafter, the pathological specimen is also referred to as a sample S. The image here refers to an image converted into red, green, and blue (RGB) colors from a constituent ratio or a waveform regarding color elements constituting the spectrum or autofluorescence originated from the sample, or refers to a luminance distribution in a specific wavelength band, and the like.

The storage unit 521 includes a nonvolatile storage medium such as a hard disk drive or flash memory, and a storage control unit that controls writing and reading of data to and from the storage medium. The storage unit 521 stores spectral data indicating a correlation between each wavelength of light emitted by each of the plurality of line illumination beams included in the excitation unit 510 and fluorescence received by the camera of the spectral imaging unit 530. In addition, the storage unit 521 stores in advance information indicating a standard spectrum of autofluorescence related to a sample (pathological specimen) to be observed and information indicating a standard spectrum of a single dye used to stain the sample.

The data calibration unit 522 configures spectral data stored in the storage unit 521 based on the captured image captured by the camera of the spectral imaging unit 530. The image forming unit 523 forms a fluorescence image of the sample based on the spectral data and an interval Δy of the plurality of line illumination beams emitted from the excitation unit 510. The processing unit 502, including the data calibration unit 522, the image forming unit 523, etc., can be implemented by hardware elements used in a computer, such as a central processing unit (CPU), random access memory (RAM), and read only memory (ROM), and necessary programs (software). Instead of or in addition to the CPU, a programmable logic device (PLD) such as a field programmable gate array (FPGA), a digital signal processor (DSP), an application specific integrated circuit (ASIC), or the like may be used.

The display unit 503 displays, for example, various types of information such as an image based on the fluorescence image formed by the image forming unit 523. The display unit 503 may be constituted by, for example, a monitor integrally attached to the processing unit 502, or may be a display device connected to the processing unit 502. For example, the display unit 503 includes: a display element such as a liquid crystal device or an organic EL device; and a touch sensor, and functions as a user interface (UI) that displays input setting of imaging conditions, captured images, and the like.

Next, details of the observation unit 501 will be described with reference to FIG. 49. Here, a description will be given on the assumption that the excitation unit 510 includes two line illumination beams Ex1 and Ex2 that each emit light beams of two wavelengths. For example, the line illumination beam Ex1 emits light having a wavelength of 405 nm and light having a wavelength of 561 nm, and the line illumination beam Ex2 emits light having a wavelength of 488 nm and light having a wavelength of 645 nm.

As illustrated in FIG. 49, the excitation unit 510 includes a plurality of excitation light sources L1, L2, L3, and L4. Each of the excitation light sources L1 to L4 includes a laser light source that outputs a laser beam each having a wavelength of 405 nm, 488 nm, 561 nm, and 645 nm, respectively. For example, each of the excitation light sources L1 to L4 includes a light emitting diode (LED), a laser diode (LD), or the like.

Furthermore, the excitation unit 510 includes: a plurality of collimator lenses 511; a plurality of laser line filters 512; a plurality of dichroic mirrors 513a, 513b, and 513c, each corresponding to the individual excitation light sources L1 to L4; a homogenizer 514; a condenser lens 515; and an incident slit unit 516.

The laser beam emitted from the excitation light source L1 and the laser beam emitted from the excitation light source L3 are collimated by the collimator lens 511, transmitted through the laser line filter 512 for cutting out-of-band components of each wavelength band, and is formed into a coaxial beam by the dichroic mirror 513a. The two coaxial laser beams undergoes further beam-shaping by the homogenizer 514 such as a fly-eye lens and the condenser lens 515 so as to be the line illumination beam Ex1.

Similarly, the laser beam emitted from the excitation light source L2 and the laser beam emitted from the excitation light source L4 are formed into a coaxial beam by the dichroic mirrors 513b and 513c so as to be the line illumination, namely, the line illumination beam Ex2 which is non-coaxial to the line illumination beam Ex1. The line illumination beams Ex1 and Ex2 form non-coaxial line illumination beam (namely, a primary image) separated by a distance Δy in the incident slit unit 516 having a plurality of incident slits each permitting the passage of each of the line illumination beams Ex1 and Ex2.

The present embodiment will describe an example in which the four laser beams are formed into two coaxial beams and two non-axial beams. However, it is also allowable to form two laser beams into two non-axial beams or form four laser beams into four non-axial beams.

The sample S on the stage 520 is irradiated with the primary image through the observation optical system 540. The observation optical system 540 includes a condenser lens 541, dichroic mirrors 542 and 543, an objective lens 544, a band pass filter 545, and a condenser lens 546. The condenser lens 546 is an example of an imaging lens. The line illumination beams Ex1 and Ex2 are collimated by the condenser lens 541 paired with the objective lens 544, reflected by the dichroic mirrors 542 and 543, transmitted through the objective lens 544, and applied to the sample S on the stage 520.

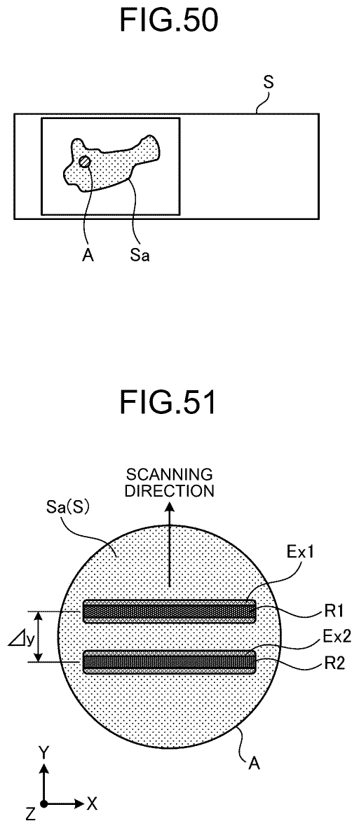

Here, FIG. 50 is a diagram illustrating an example of the sample S according to the present embodiment. FIG. 50 illustrates a state in which the sample S is viewed from the irradiation directions of the line illumination beams Ex1 and Ex2 as excitation light. The sample S is typically formed with a slide including an observation target Sa such as a tissue section as illustrated in FIG. 50, but it is needless to say that the sample S may be formed with others. The observation target Sa is, for example, a biological sample material such as a nucleic acid, a cell, a protein, a bacterium, or a virus. The sample S, namely, the observation target Sa, is stained with a plurality of fluorescent dyes. The observation unit 501 observes the sample S magnified at a desired magnification.

FIG. 51 is an enlarged view illustrating a region A in which the sample S according to the present embodiment is irradiated with the line illumination beams Ex1 and Ex2. In the example of FIG. 51, two line illumination beams Ex1 and Ex2 are arranged in the region A, and imaging areas R1 and R2 of the spectral imaging unit 530 are arranged so as to overlap the line illumination beams Ex1 and Ex2 respectively. The two line illumination beams Ex1 and Ex2 are individually parallel to the Z-axis direction, and are disposed away from each other by a predetermined distance (Δy) in the Y-axis direction.

line illumination beams Ex1 and Ex2 are formed on the surface of the sample S as illustrated in FIG. 51. As illustrated in FIG. 49, the fluorescence excited in the sample S by the line illumination beams Ex1 and Ex2 is condensed by the objective lens 544, reflected by the dichroic mirror 543, transmitted through the dichroic mirror 542 and the band pass filter 545 that cuts off the excitation light, condensed again by the condenser lens 546, so as to be incident on the spectral imaging unit 530.

As illustrated in FIG. 49, the spectral imaging unit 530 includes an observation slit unit 531, an imaging element 532, a first prism 533, a mirror 534, a diffraction grating 535, and a second prism 536. The diffraction grating 535 is a wavelength dispersion element, for example.

In the example of FIG. 49, the imaging element 532 includes two imaging elements 532a and 532b. The imaging element 532 receives a plurality of light beams that has undergone wavelength dispersion by the diffraction grating 535, that is, fluorescence, for example. The imaging element 532 is constituted by employing a two-dimensional imager such as a Charge Coupled Device (CCD) and a Complementary Metal Oxide Semiconductor (CMOS), for example.

The observation slit unit 531 is disposed at the condensing point of the condenser lens 546, and has the same number of observation slits as the number of excitation lines, that is, two observation slits in the example of FIG. 49. The number of observation slits is not particularly limited, and may be four, for example. The fluorescence spectra originated from the two excitation lines that have passed through the observation slit unit 531 are separated by the first prism 533 and reflected by the grating surface of the diffraction grating 535 via the mirror 534, so as to be further separated into fluorescence spectra of individual excitation wavelengths. The four separated fluorescence spectra are incident on the imaging elements 532a and 532b via the mirror 534 and the second prism 536, and are developed, as spectral data, into spectral data (x, λ) expressed by a position x in the line direction and a wavelength λ. The spectral data (x, λ) is a pixel value, that is, a value of a pixel at the position x in the row direction and at a position of the wavelength λ in the column direction among pixels included in the imaging element 532. The spectral data (x, λ) may be simply described as spectral data.

Note that the pixel size (nm/Pixel) of the imaging elements 532a and 532b is not particularly limited, and is set to 2 nm/Pixel or more and 20 nm/Pixel or less, for example. This variance value may be achieved optically or by setting a pitch of the diffraction grating 535, or may be achieved by using hardware binning of the imaging elements 532a and 532b. In addition, the dichroic mirror 542 and the band pass filter 545 are inserted in the middle of the optical path so as to prevent the excitation light, that is, the line illumination beams Ex1 and Ex2 from reaching the imaging element 532.

The line illumination beams Ex1 and Ex2 are not limited to the configuration with a single wavelength, and each may have a configuration with a plurality of wavelengths. When each of the line illumination beams Ex1 and Ex2 includes a plurality of wavelengths, the fluorescence excited by each of the line illumination beams Ex1 and Ex2 also includes a plurality of spectra. In this case, the spectral imaging unit 530 includes a wavelength distribution element for separating the fluorescence into a spectrum originated from the excitation wavelength. The wavelength distribution element includes a diffraction grating, a prism, or the like, and is typically disposed on an optical path between the observation slit unit 531 and the imaging element 532.

The stage 520 and the scanning mechanism 550 constitute an X-Y stage, and cause the sample S to move in the X-axis direction and the Y-axis direction in order to acquire a fluorescence image of the sample S. In Whole Slide Imaging (WSI), an operation of scanning the sample S in the Y-axis direction, then moving the sample S in the X-axis direction, and further performing scanning in the Y-axis direction is repeated. With the scanning mechanism 550, spectra of the dye, namely, fluorescence spectra, spatially separated by the distance Δy and excited at different excitation wavelengths on the sample S, namely, the observation target Sa, can be continuously recorded in the Y-axis direction.

The scanning mechanism 550 causes the irradiation light application position in the sample S to change over time. For example, the scanning mechanism 550 scans the stage 520 in the Y-axis direction. By the scanning mechanism 550, the plurality of line illumination beams Ex1 and Ex2 can be scanned with respect to the stage 520 in the Y-axis direction, that is, in the arrangement direction of the line illumination beams Ex1 and Ex2. Not limited to this, and scanning may be performed in the Y-axis direction with a plurality of line illumination beams Ex1 and Ex2 by a galvanometer mirror disposed in the middle of the optical system. The data originated from each of the line illumination beams Ex1 and Ex2, represented by two-dimensional data or three-dimensional data, for example, is data whose coordinates are shifted by the distance Δy with respect to the Y axis. Accordingly, the data is corrected and output based on the distance Δy stored in advance or the value of the distance Δy calculated from the output of the imaging element 532.

As illustrated in FIG. 49, the non-fluorescence observation unit 570 includes a light source 571, a dichroic mirror 543, an objective lens 544, a condenser lens 572, an imaging element 573, and the like. In the example of FIG. 49, the non-fluorescence observation unit 570 is illustrated as an observation system by dark field illumination.

The light source 571 is disposed on the side facing the objective lens 544 across the stage 520, and irradiates the sample S on the stage 520 with illumination light from the side opposite to the line illumination beams Ex1 and Ex2. In the case of dark field illumination, the light source 571 illuminates from the outside of the numerical aperture (NA) of the objective lens 544, and the light (dark field image) diffracted by the sample S is photographed by the imaging element 573 via the objective lens 544, the dichroic mirror 543, and the condenser lens 572. By using dark field illumination, even an apparently transparent sample such as a fluorescent stained sample can be observed with contrast.

Note that this dark field image may be observed simultaneously with fluorescence and used for real-time focusing. In this case, the illumination wavelength can be determined by selecting a wavelength that would not affect fluorescence observation. Not limited to the observation system that acquires the dark field image, the non-fluorescence observation unit 570 may include an observation system that can acquire a non-fluorescence image such as a bright field image, a phase difference image, a phase image, and an in-line hologram image. For example, examples of an applicable method of acquiring a non-fluorescence image include various observation methods such as a Schlieren method, a phase difference contrast method, a polarization observation method, and an epi-illumination method. The illumination light source need not be located below the stage 520, and may be located above the stage 520 or around the objective lens 544. Furthermore, not only a method of performing focus control in real time, but also another method such as a pre-focus map method of recording focus coordinates (Z coordinates) in advance may be adopted.

In the above description, the line illumination as the excitation light is formed with the two line illumination beams Ex1 and Ex2, but is not limited thereto, and may be three, four, or five or more. In addition, each line illumination beam may include a plurality of excitation wavelengths selected to suppress degradation of color separation performance as much as possible. In addition, even with one line illumination beam, by using the excitation light source formed with a plurality of excitation wavelengths and recording the individual excitation wavelengths in association with data obtained by the imaging element 532, it is still possible to obtain a polychromatic spectrum although it is not possible to obtain separability equal to the case using non-axial parallel beams.

The application example in which the technology according to the present disclosure is applied to the fluorescence observation device 500 has been described above. Note that the above-described configuration described with reference to FIGS. 48 and 49 is merely an example, and the configuration of the fluorescence observation device 500 according to the present embodiment is not limited to the example. For example, the fluorescence observation device 500 do not necessarily have to include all of the components illustrated in FIGS. 48 and 49, or may include a component not illustrated in FIG. 48 or 49

Since other configurations, operations, and effects may be similar to those in the above-described embodiment, detailed description thereof will be omitted here.

### 5. Hardware Configuration

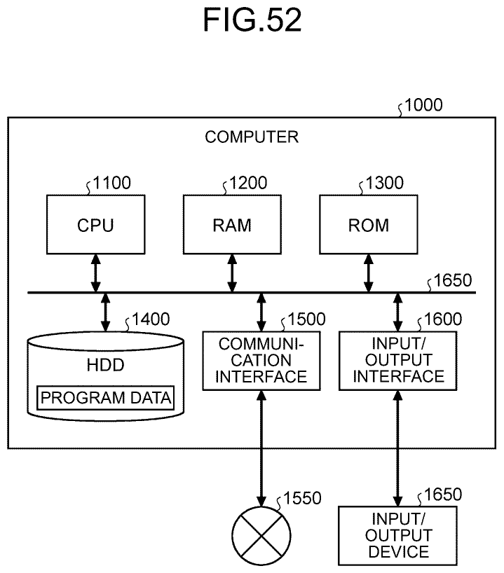

The information devices such as the control unit 131 and the computation unit 132 according to the above-described embodiments are implemented by a computer 1000 having a configuration as illustrated in FIG. 52, for example. Hereinafter, the derivation device 40 according to the above-described embodiment will be described as an example. FIG. 52 is a hardware configuration diagram illustrating an example of the computer 1000 that implements functions of the control unit 131 and the computation unit 132. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops the program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records a response generation program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting between an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on a predetermined computer-readable recording medium (or media). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, in a case where the computer 1000 functions as the control unit 131, the computation unit 132, and the like according to the above embodiment, the CPU 1100 of the computer 1000 executes a diagnosis support program loaded on the RAM 1200 to implement the functions of the control unit 131, the computation unit 132, and the like. In addition, the HDD 1400 stores the diagnosis support program according to the present disclosure and data in the storage unit 133. Furthermore, for example, when the computer 1000 functions as the display control device 23 according to the above-described embodiment, the CPU 1100 of the computer 1000 executes the display control program loaded on the RAM 1200 to implement the functions of the image acquisition unit 23a, the display control unit 23b, and the like. In addition, the HDD 1400 stores a display control program according to the present disclosure. While the CPU 1100 executes program data 1450 read from the HDD 1400, the CPU 1100 may acquire the diagnosis support program and display control program from another device via the external network 1550, as another example.

### [Others]

Among individual processes described in the above embodiments, all or a part of the processes described as being performed automatically may be manually performed, or the processes described as being performed manually can be performed automatically by a known method. In addition, the processing procedures, specific names, and information including various data and parameters illustrated in the above Literatures or drawings can be arbitrarily altered unless otherwise specified. For example, various types of information illustrated in each of the drawings are not limited to the information illustrated.

In addition, each of components of each device is provided as a functional and conceptional illustration and thus does not necessarily need to be physically configured as illustrated. That is, the specific form of distribution/integration of each device is not limited to those depicted in the drawings, and all or a part thereof may be functionally or physically distributed or integrated into arbitrary units according to various loads and use conditions.

Furthermore, the above-described embodiments and modifications can be appropriately combined within a range implementable without contradiction of processes.

The effects described in the present specification are merely examples, and thus, there may be other effects, not limited to the exemplified effects.

Note that the present technology can also have the following configurations.

(1)

A biological sample material observation system comprising
a control unit that determines, based on a relationship between information related to a luminance distribution of first image data acquired by imaging a sample by a first imaging system and information related to a luminance distribution of second image data acquired by imaging the sample by a second imaging system, and based on information related to a luminance distribution of third image data acquired by imaging a biological sample material different from the sample by the first imaging system, an imaging condition to be used at a time of imaging the biological sample material by the second imaging system.
   (2)

The biological sample material observation system according to (1), wherein
the control unit further estimates information related to a luminance distribution of fourth image data to be acquired in a case where the biological sample material is imaged by the second imaging system from the information related to the luminance distribution of the third image data based on the relationship, and determines the imaging condition based on the estimated information related to the luminance distribution of the fourth image data.
   (3)

The biological sample material observation system according to (2), wherein
the control unit further creates a two-dimensional histogram having a luminance value of the first image data as a first axis and a luminance value of the second image data as a second axis, and normalizes information related to a luminance distribution of the first axis in the two-dimensional histogram, so as to create, as the relationship, a first transformation matrix, the first transformation matrix being a matrix to transform the information related to the luminance distribution of the third image data into the information related to the luminance distribution of the fourth image data.
   (4)

The biological sample material observation system according to (3), wherein
the first image data and the second image data have different resolutions, and
the control unit performs image processing on at least one of the first image data or the second image data to achieve matching of resolutions of the first image data and the second image data, and creates the two-dimensional histogram using the first image data and the second image data having the matched resolution.
   (5)

The biological sample material observation system according to (4), wherein
the first image data and the second image data are image data of an identical sample, the sample being different from the biological sample material, and
the control unit creates the two-dimensional histogram for each sample from an image pair of the first image data and the second image data obtained by imaging each of a plurality of samples by the first imaging system and the second imaging system, creates a plurality of second transformation matrices based on each of the plurality of created two-dimensional histograms, and creates the first transformation matrix by taking an average value or a moving average value of the plurality of second transformation matrices.
   (6)

The biological sample material observation system according to (4), wherein
the first image data and the second image data are image data of an identical sample, the sample being different from the biological sample material, and
the control unit creates the two-dimensional histogram for each sample from an image pair of the first image data and the second image data obtained by imaging each of a plurality of samples by the first imaging system and the second imaging system, creates a plurality of second transformation matrices based on each of the plurality of created two-dimensional histograms, and sets the second transformation matrix selected from the plurality of second transformation matrices, as the first transformation matrix.
   (7)

The biological sample material observation system according to (5) or (6), wherein
the plurality of samples is of a same type in at least one of a type of a tissue specimen, a type of a fluorescent dye used for staining, and a staining condition at a time of staining.
   (8)

The biological sample material observation system according
to any one of (2) to (7), wherein the control unit determines a reference luminance value from the estimated fourth image data, and determines the imaging condition based on the reference luminance value.
   (9)

The biological sample material observation system according to (8), wherein
the reference luminance value is any of luminance values including: a luminance value of a predetermined percentile value or an integer multiple of the percentile value, on a one-dimensional histogram representing information related to the luminance distribution of the fourth image data; a luminance value exhibited on an X-intercept of a straight line representing a gradient of the one-dimensional histogram at a predetermined luminance value; and a luminance value determined based on a luminance value representing information related to a peak of a luminance distribution on the one-dimensional histogram.
   (10)

The biological sample material observation system according to (8) or (9), wherein
the control unit determines the imaging condition such that the reference luminance value approaches a predetermined appropriate luminance value.
   (11)

The biological sample material observation system according to any one of (2) to (10), wherein
the control unit further causes a user to adjust the imaging condition, and determines the imaging condition to be set in the second imaging system based on the adjusted imaging condition.
   (12)

The biological sample material observation system according to (11), wherein
the control unit further performs control to generate, based on the third image data, fifth image data predicted to be acquired in a case where the biological sample material is imaged by the second imaging system, and control to display the fifth image data to the user.
   (13)

The biological sample material observation system according to any one of (1) to (12), wherein
the imaging condition includes at least one of an exposure time, a signal gain, and a diaphragm in the second imaging system, and intensity of excitation light to be applied to the biological sample material at the time of imaging of the biological sample material.
   (14)

The biological sample material observation system according to (13), wherein
the control unit determines, as the imaging condition for setting the second imaging system, an imaging condition in which at least one of the signal gain and the diaphragm has been adjusted in preference to the exposure time and the intensity of the excitation light, among the exposure time, the signal gain, the diaphragm, and the intensity of the excitation light.
   (15)

The biological sample material observation system according to any one of (1) to (14), further comprising the first imaging system and the second imaging system.

(16)

The biological sample observation system according to (15), wherein
the first imaging system and the second imaging system has, at least partially, a common configuration.
   (17)

The biological sample material observation system according to any one of (1) to (16), wherein
the biological sample material has undergone fluorescent labeling, and
the first imaging system and the second imaging system include an excitation light source that excites the biological sample material.
   (18)

The biological sample material observation system according to any one of (2) to (12), further comprising an analysis unit that analyzes the fourth image data acquired by imaging the biological sample material using the second imaging system in which the imaging condition is set.

(19)

The biological sample material observation system according to any one of (1) to (18), wherein
the biological sample material imaged by the first imaging system and the biological sample material imaged by the second imaging system are identical or similar tissue sections.
   (20)

A biological sample material observation method comprising
determining, based on a relationship between information related to a luminance distribution of first image data acquired by imaging a sample by a first imaging system and information related to a luminance distribution of second image data acquired by imaging the sample by a second imaging system, and based on information related to a luminance distribution of third image data acquired by imaging a biological sample material different from the sample by the first imaging system, an imaging condition to be used at a time of imaging the biological sample material by the second imaging system.
   (21)

A data set creation method, comprising:
imaging each of a plurality of samples individually by a first imaging system and a second imaging system so as to create a plurality of image pairs of first image data acquired by the first imaging system and second image data acquired by the second imaging system;
grouping the plurality of image pairs into libraries for each type of the sample;
creating a two-dimensional histogram for each of the image pairs included in the library, the two-dimensional histogram having a luminance value of the first image data as a first axis and a luminance value of the second image data as a second axis; and
normalizing the information related to the luminance distribution of the first axis in the two-dimensional histogram to create a transformation matrix based on a relationship between the information related to the luminance distribution of the image data acquired by the first imaging system and the information related to the luminance distribution of the image data acquired by the second imaging system.

### REFERENCE SIGNS LIST

1 DIAGNOSIS SUPPORT SYSTEM
10, 20 PATHOLOGY SYSTEM
11, 21 MICROSCOPE
12, 22 SERVER
13, 23 DISPLAY CONTROL DEVICE
14, 24 DISPLAY DEVICE
30 MEDICAL INFORMATION SYSTEM
40 DERIVATION DEVICE
100 MICROSCOPIC IMAGING DEVICE
110 FIRST IMAGING SYSTEM
111 FIRST LIGHT SOURCE UNIT
112 FIRST DETECTION UNIT
120 SECOND IMAGING SYSTEM
121 SECOND LIGHT SOURCE UNIT
122 SECOND DETECTION UNIT
131 CONTROL UNIT
132 COMPUTATION UNIT
133 STORAGE UNIT
300 IMAGING CONDITION ADJUSTMENT GUI
310, 310A to 310D IMAGING CONDITION ADJUSTMENT UNIT
311 SLIDER
312 SLIDER BAR
320 REFERENCE IMAGE DISPLAY UNIT

1. A biological sample material observation system comprising
a control unit that determines, based on a relationship between information related to a luminance distribution of first image data acquired by imaging a sample by a first imaging system and information related to a luminance distribution of second image data acquired by imaging the sample by a second imaging system, and based on information related to a luminance distribution of third image data acquired by imaging a biological sample material different from the sample by the first imaging system, an imaging condition to be used at a time of imaging the biological sample material by the second imaging system.

2. The biological sample material observation system according to claim 1, wherein
the control unit further estimates information related to a luminance distribution of fourth image data to be acquired in a case where the biological sample material is imaged by the second imaging system from the information related to the luminance distribution of the third image data based on the relationship, and
determines the imaging condition based on the estimated information related to the luminance distribution of the fourth image data.

3. The biological sample material observation system according to claim 2, wherein
the control unit further creates a two-dimensional histogram having a luminance value of the first image data as a first axis and a luminance value of the second image data as a second axis, and normalizes information related to a luminance distribution of the first axis in the two-dimensional histogram, so as to create, as the relationship, a first transformation matrix, the first transformation matrix being a matrix to transform the information related to the luminance distribution of the third image data into the information related to the luminance distribution of the fourth image data.

4. The biological sample material observation system according to claim 3, wherein
the first image data and the second image data have different resolutions, and
the control unit performs image processing on at least one of the first image data or the second image data to achieve matching of resolutions of the first image data and the second image data, and creates the two-dimensional histogram using the first image data and the second image data having the matched resolution.

5. The biological sample material observation system according to claim 4, wherein
the first image data and the second image data are image data of an identical sample, the sample being different from the biological sample material, and
the control unit creates the two-dimensional histogram for each sample from an image pair of the first image data and the second image data obtained by imaging each of a plurality of samples by the first imaging system and the second imaging system, creates a plurality of second transformation matrices based on each of the plurality of created two-dimensional histograms, and creates the first transformation matrix by taking an average value or a moving average value of the plurality of second transformation matrices.

6. The biological sample material observation system according to claim 4, wherein
the first image data and the second image data are image data of an identical sample, the sample being different from the biological sample material, and
the control unit creates the two-dimensional histogram for each sample from an image pair of the first image data and the second image data obtained by imaging each of a plurality of samples by the first imaging system and the second imaging system, creates a plurality of second transformation matrices based on each of the plurality of created two-dimensional histograms, and sets the second transformation matrix selected from the plurality of second transformation matrices, as the first transformation matrix.

7. The biological sample material observation system according to claim 5, wherein
the plurality of samples is of a same type in at least one of a type of a tissue specimen, a type of a fluorescent dye used for staining, and a staining condition at a time of staining.

8. The biological sample material observation system according to claim 2, wherein
the control unit determines a reference luminance value from the estimated fourth image data, and determines the imaging condition based on the reference luminance value.

9. The biological sample material observation system according to claim 8, wherein
the reference luminance value is any of luminance values including: a luminance value of a predetermined percentile value or an integer multiple of the percentile value, on a one-dimensional histogram representing information related to the luminance distribution of the fourth image data; a luminance value exhibited on an X-intercept of a straight line representing a gradient of the one-dimensional histogram at a predetermined luminance value; and a luminance value determined based on a luminance value representing information related to a peak of a luminance distribution on the one-dimensional histogram.

10. The biological sample material observation system according to claim 8, wherein
the control unit determines the imaging condition such that the reference luminance value approaches a predetermined appropriate luminance value.

11. The biological sample material observation system according to claim 2, wherein
the control unit further causes a user to adjust the imaging condition, and determines the imaging condition to be set in the second imaging system based on the adjusted imaging condition.

12. The biological sample material observation system according to claim 11, wherein
the control unit further performs control to generate, based on the third image data, fifth image data predicted to be acquired in a case where the biological sample material is imaged by the second imaging system, and control to display the fifth image data to the user.

13. The biological sample material observation system according to claim 1, wherein
the imaging condition includes at least one of an exposure time, a signal gain, and a diaphragm in the second imaging system, and intensity of excitation light to be applied to the biological sample material at the time of imaging of the biological sample material.

14. The biological sample material observation system according to claim 13, wherein
the control unit determines, as the imaging condition for setting the second imaging system, an imaging condition in which at least one of the signal gain and the diaphragm has been adjusted in preference to the exposure time and the intensity of the excitation light, among the exposure time, the signal gain, the diaphragm, and the intensity of the excitation light.

15. The biological sample material observation system according to claim 1, further comprising the first imaging system and the second imaging system.

16. The biological sample material observation system according to claim 1, wherein
the biological sample material has undergone fluorescent labeling, and
the first imaging system and the second imaging system include an excitation light source that excites the biological sample material.

17. The biological sample material observation system according to claim 2, further comprising an analysis unit that analyzes the fourth image data acquired by imaging the biological sample material using the second imaging system in which the imaging condition is set.

18. The biological sample material observation system according to claim 1, wherein
the biological sample material imaged by the first imaging system and the biological sample material imaged by the second imaging system are identical or similar tissue sections.

19. A biological sample material observation method comprising
determining, based on a relationship between information related to a luminance distribution of first image data acquired by imaging a sample by a first imaging system and information related to a luminance distribution of second image data acquired by imaging the sample by a second imaging system, and based on information related to a luminance distribution of third image data acquired by imaging a biological sample material different from the sample by the first imaging system, an imaging condition to be used at a time of imaging the biological sample material by the second imaging system.

20. A data set creation method, comprising:
imaging each of a plurality of samples individually by a first imaging system and a second imaging system so as to create a plurality of image pairs of first image data acquired by the first imaging system and second image data acquired by the second imaging system;
grouping the plurality of image pairs into libraries for each type of the sample;
creating a two-dimensional histogram for each of the image pairs included in the library, the two-dimensional histogram having a luminance value of the first image data as a first axis and a luminance value of the second image data as a second axis; and
normalizing the information related to the luminance distribution of the first axis in the two-dimensional histogram to create a transformation matrix based on a relationship between the information related to the luminance distribution of the image data acquired by the first imaging system and the information related to the luminance distribution of the image data acquired by the second imaging system.
